(19) United States
(12) Patent Application Publication
(10) Pub. No.: US 2011/0218041 A1
(43) Pub. Date: Sep. 8, 2011

(54) GAME MACHINE AND COMPUTER GAME PROGRAM

(75) Inventors: Tetsuro Itami, Tokyo (JP); Yumi Matsuura, Tokyo (JP); Miyuki Ariga, Tokyo (JP)

(73) Assignee: KONAMI DIGITAL ENTERTAINMENT CO., LTD., Tokyo (JP)

(21) Appl. No.: 13/124,361

(22) PCT Filed: Oct. 9, 2009
(86) PCT No.: PCT/JP2009/067656

§ 371 Date: Apr. 14, 2011

(30) Foreign Application Priority Data
Dec. 11, 2008 (JP) 2008-315714
Feb. 17, 2009 (JP) 2009-033896

(51) Int. Cl. G06F 17/00

(52) U.S. Cl. 463/31

(57) ABSTRACT

There is provided a game machine configured such that the activity is enhanced in a game where points are gained depending on the state of the plural component objects being piled up in a game image.

The shot line to be moved out of the lines of ball masses BM, BM100 constituted by plural balls B, B100, by the moving line determination operation by a player, and the moving distance for which the moving line ML is moved is determined by the moving distance determination operation by the player. The plural balls B, B100 on the determined moving line are moved in the line direction depending on the determined moving distance. In the case that, after the moving line moving, the plural balls B, B100 in the ball masses BM establish a predetermined state, the plural balls B, B100 are deleted, and the balls B, B100 arranged on the column of the deleted balls B, B100 are moved in the column direction.

### TECHNICAL FIELD

The present invention relates to a game machine and computer game program in which a puzzle game based on a plurality of component objects is executed.

### BACKGROUND ART

There is already well-known a so-called falling objects game in which a plurality of falling objects are fell downward to be piled as component objects in a game image, and points are given depending on the piled component-object state (for example, refer to the patent literature 1).
Patent Literature 1:JP-A-H10-66784

### SUMMARY OF INVENTION

### Technical Problem

However, in the well-known falling objects game, few elements are controlled by following operations performed by a player, for example, the player can do a little more than determine the position where the falling object falls. Additionally, in the well-known falling objects game, although there is an already known construction that when battling with another player, each of the players performs operations to the component objects given to himself/herself to compete for game results, there does not exist such puzzle game that the operation which a player performs to his/her own component objects also affects the component objects of other players.

Then, the aim is, for a game in which points are gained depending on a piled component-object state in the game image, providing a game machine and a computer game program configured such that more elements are determined by operations performed by a player to enhance the activity of the game. Also, the aim is providing a game machine and a computer game program which is constructed so that operations performed by a player affects to not only his/her own component objects, but also competitor's component objects.

### Solution to Problem

A first game machine as one aspect of the present invention solves the above problems by being configured as a game machine comprising: an operation input portion which accepts operations performed by a player; a display portion which displays a game image; and a game control portion which controls a game where a state of a collective body constituted by plural kinds of component objects is changed in reply to the operation by the player in the display portion; wherein the game control portion has: a collective body display portion which makes the display portion display the collective body constituted by plural columns and plural lines where the plural kinds of component objects are arranged in a column direction or in a line direction; a moving line determination portion which determines a moving line to be moved out of the plural lines of the collective body; a moving distance determination portion which determines a moving distance for which the moving line is moved in replay to a moving distance determination operation by the player; a move execution portion which, when the moving distance is determined by the moving distance determination portion, to the collective body displayed by the display portion, moves the component objects arranged on the moving line in the line direction depending on the moving distance; a state determination portion which, to the collective body post-moved by the move execution portion, determines whether or not the plural kinds of component objects constituting the collective body have established a predetermined state with respect to the kinds; a component object deletion portion which, when it is determined that the predetermined state has been established, generates a deletion portion in the collective body post-moved by deleting the plural component objects establishing the predetermined state in the collective body; and a post-deletion move portion which moves the component objects arranged on the column of each deleted component object in the column direction so as to fill up the deletion portion generated.

By the first game machine of the present invention, it is possible to make the player determine the moving distance of the moving line by the moving distance determination portion. By the move execution portion, the determined moving line is moved depending on the determined moving distance, and in a case that plural component objects establishing the predetermined state with respect to the kind occur, the plural component objects are deleted, and the component objects existing in the column direction are moved in the column direction so as to fill up the deleted portion. In a game the aim of which is the deletion of all component objects constituting the collective body, and a game where points are gained by deleting the component objects, the operation for determining the moving distance of the moving line is required to the player. Especially, in a case that the operation requires speed, it is possible to enhance the activity of the game. Further, in a case that the player is not allowed to try the operation again, it is possible to provide a game requiring high operation ability to a player.

As the moving line determination operation, a case where the game control portion determines the moving line sequentially or at random and a case where the moving line is determined depending on an operation by the player may be included. The operation by the player may include a case where the player is allowed to select one key corresponding to his/her desired line out of keys corresponding to the lines respectively and a case where the player is allowed to input a line number corresponding to his/her desired line. As the moving distance determination operation may include a case where the player is allowed to select one key corresponding to his/her desired moving distance out of keys each corresponding to each moving distance, and a case where the player is allowed to input his/her desired moving distance. In the present invention, the line direction is a direction in which the lines are provided, and the column direction is a direction in which the columns are provided. The present invention includes both a case where the line direction and the column direction are perpendicular to each other and a case where the line direction and the column direction are not perpendicular to each other. It is enough that the plurality of component objects constituting the collective body of the present invention are arranged in the two directions, that is, the line direction and the column direction. Each of the line direction and the column direction includes two directions which are opposite to each other. The present invention can be configured such that the component objects move in any one of the two opposite directions, or the direction in which the component objects move is changeable appropriately.

“To establish a predetermined state with respect to the kind” may include a case where a predetermined number of the component objects which are the same kind establish a predetermined shape, a case where the kinds of a predetermined number of the component objects show a predetermined arrangement and the like. Additionally, As the kind of the component object, a case where the kind indicates the color and/or pattern in a situation where the shape is same, and a case where the kind indicates the shape are included. In the present invention, for example, the game may be configured such that points are obtained each time the component objects are deleted, or points are obtained when all of the component objects in the collective body are deleted within a predetermined time period.

The moving distance determination portion may determine the moving distance depending on a volume of the moving distance determination operation. Thereby, for example, the moving distance determination operation may be configured such that the moving distance is determined in accordance with the duration that a predetermined key in the operation input portion is pressed down, or the moving distance is determined in a stepwise manner depending on the number of times that the predetermined key is pressed down. Additionally, it is preferable that a moving distance presenting portion is displayed in the game image to recognize a change of moving distance in accordance with the volume of performing the moving distance determination operation.

The moving distance determination portion may increase, after the moving distance determination operation being performed, the moving distance each time when the moving distance determination operation is performed in a predetermined time, and when the moving distance determination operation is not performed in the predetermined time, may determine the moving distance at the moment as the moving distance for which the determined moving line is moved. Thereby, when the player performs the moving distance determination operation consecutively his/her desired times, it is possible to move the moving line for his/her desired moving distance. When the moving distance determination operation is not performed within a predetermined time period, the moving distance at the moment is determined as a final moving distance. As the moving distance determination operation requires speed, it is possible to provide a game effecting a high activity.

The moving line determination portion may indicate sequentially a specific line out of the plural lines displayed in the game image, and determine as a line to be moved, the specific line at the moment when the moving distance determination operation is performed by the player. Thereby, it is possible to allow a player to determine the moving line. As the sequence of indicating the specific line, a case of indicating sequentially from the edge and a case of indicating by following a predetermined sequence. When the specific line is indicated by following a predetermined sequence, it is possible to make the player suppose the next specific line. Moreover, depending on the speed at which the specific line is indicated sequentially, the game can be configured such that a high speed is required to the operation. As a way how to indicate the specific, a case where the specific line is shown in a state different from the state of the other lines, and a case where a symbol to indicate the specific line is displayed.

The move execution portion, in a case that a consecutive move operation is performed by the player after the component object deletion portion deleting the component objects establishing the predetermined state until the post-deletion move portion moving the component objects located in the column direction of the deleted component objects, may further move the component objects on the moving line for a predetermined moving distance in the line direction in the collective body where the plural component objects have been deleted. Thereby, even after the plural component objects establishing the predetermined state being deleted, it is possible to further move the moving line in the line direction before the move in the column direction starts. Namely, it is possible to further move the moving line in a state of original component objects. The moving line in this case is the moving line determined by the moving line determination operation in advance, and a predetermined moving distance is set as the moving distance. As the predetermined moving distance, a constant moving distance may be set, or the moving distance determined by the moving distance determination operation in advance may be used.

The state determination portion, after the component objects being moved by the post-deletion move portion, may further determine whether or not the plural kinds of component objects in the post-moved collective body establish the predetermined state. Thereby, by the state determination portion, in a case where it is determined that the plural component objects further establish the predetermined state in the collective body after the move by the post-deletion move portion, it is possible to further move the component objects in the column direction by the post-deletion move portion. Thereby, the chain of move can be realized.

The move execution portion, so as to fill up a space area where the component objects have gone in the moving line by the move in the line direction, may move in the column direction, the component object arranged on each column of the space area, and the state determination portion may determine whether the predetermined state has been established or not in a state of the collective body after the move in the line direction and the column direction relating to the moving line. Thereby, it is possible to make the state determination portion determine in a state where the space area generated by the move of the moving line has been filled up.

The game machine may further comprise a component object information storage portion which stores component object information where the kind of the component object is set for each of the plural columns in an order that the component object is displayed by the display portion, the collective body display portion may supply and display sequentially by following the order that the component object is displayed, the component objects to the space area where the component objects have gone by the move in the column direction, the kind of each component object being set for each of the columns of the space area. Thereby, as new component objects are supplied in the column direction, it is possible to maintain until the end of component object information, the number of component objects arranged in the column direction of the collective body, that is, the number of lines of the collective body displayed in the game image. Further, in a case where it is a game end condition that all of the component objects constituting the collective body are deleted, it is possible to control a duration time of the game in accordance with the volume of the component object information. Further, the move execution portion may delete at least one component object which is protruded out of the predetermined shape by the move in the line direction of the moving line. Thereby, it is possible to maintain the number of component objects arranged in the line direction, that is, the number of columns of the collective body.

The line direction may be one direction out of left and right directions, and the column direction may be one direction out of up and down directions. Thereby, as the direction in which the component objects move is constant, the player can expect the state after the move easily, and think the strategy speedily.

The game control portion may further have a character display portion which displays a character corresponding to the player at one side of the collective body with respect to the line direction at the display portion, and the character display portion may display the character at the display portion such that the moving line is moved by a motion of the character, when the moving line is moved by the move execution portion.

Thereby, it is possible to provide a game where the moving line moves based on the motion of a character. To “display such that the moving line is moved by a motion of the character”, for example, in a case where the character is located at the destination side of the move, of moving line with respect to the collective body, the character may be made to pull the moving line, and in a case where the character is located at the side opposite to the destination side, the character may be made to push out the moving line. The state may be displayed that the moving line is moved by the character itself, or the state may be displayed that the moving line is moved by the character using a tool such as a ball, a stick, and a cord.

The game control portion may further have: an operation order determination portion which determines whether a player's operation turn has come or an other player's operation turn has come; an operation information process portion which, when the moving line is determined by the moving line determination portion and the moving distance is determined by the moving distance determination device in the player's operation turn, makes the move execution portion, the state determination portion, the component object deletion portion, and the post-deletion move portion function based on operation information indicting the moving line and the moving distance, and evaluates a result of operation performed by the player; and an other operation information process portion which, in the other player's operation turn, executes processes based on other operation information indicating the moving line and the moving distance determined depending on the operation by the other player, and the other operation information process portion, when receiving the other operation information, may make the move execution portion move the moving line indicated by the other operation information depending on the moving distance indicated by the other operation information in the other direction with respect to the line direction, make the state determination portion, the component object deletion portion, and the post-deletion move portion function based on the move by the move execution portion, and evaluate a result of operation by the other player. Thereby, it is possible to realize a battle game where the other player is set as a competitor

The game machine may further comprise a communication portion which communicates with another game machine operated by the other player, wherein the game control portion further may have: an operation information transmission portion which transmits to the other game machine, the operation information via the communication portion in the player's operation turn; and an operation information reception portion which receives from the other game machine, an other operation information which is made depending on the operation by the other player at the communication portion in the other player's operation turn. Thereby, it is possible to realize a battle game where the other player operating the other game machine is set as a competitor via the communication portion.

A Computer game program as one aspect of the present invention solves the above problem by being configured as a computer game program to be executed in a game machine comprising: an operation input portion which accepts operations by a player; a display portion which displays a game image; and a game control portion which controls a game where a state of a collective body constituted by plural kinds of component objects is changed in reply to the operation by the player in the display portion, wherein the computer game program is configured so as to make the game control portion function as: a collective body display portion which makes the display portion display the collective body constituted by plural columns and plural lines where the plural kinds of component objects are arranged in a column direction or in a line direction; a computer control portion in the game machine having the game control portion controlling a game where a state of the collective body displayed at the display portion is changed in reply to operations performed by a player; a moving line determination portion which determines a moving line to be moved out of the plural lines of the collective body; a moving distance determination portion which determines a moving distance for which the moving line is moved in replay to a moving distance determination operation by the player; a move execution portion which, when the moving distance is determined by the moving distance determination portion, to the collective body displayed by the display portion, moves the component objects arranged on the moving line in the line direction depending on the moving distance; a state determination portion which, to the collective body post-moved by the move execution portion, determines whether or not the plural kinds of component objects constituting the collective body have established a predetermined state with respect to the kinds; a component object deletion portion which, when it is determined that the predetermined state has been established, generates a deletion portion in the collective body by deleting the plural component objects establishing the predetermined state in the collective body post-moved; and a post-deletion move portion which moves the component objects arranged on the column of each deleted component object in the column direction so as to fill up the deletion portion generated. By making the computer of the game machine execute the program of the present invention, it is possible to realize the first game machine of the present invention.

A second game machine as one aspect of the present invention solves the above problem by being configured as a game machine comprising: an operation input portion which accepts operations performed by a player; a game control portion which controls a game; and a display portion which displays a game image of the game, wherein the game control portion has: a collective body setting portion which sets as the player's collective body, any one of two collective bodies each of which is constituted by plural columns and plural lines where plural kinds of component objects are arranged in a line direction and a column direction, and sets the other one of the two collective bodies as a competitor's collective body; a collective body display portion which displays in the game image, the player's collective body and the competitor's collective body so as to be adjacent to each other; a move process portion which, while moving the component objects arranged in a predetermined moving line for a predetermined moving distance in a direction of the competitor's collective body in the player's collective body depending on the operation by the player, moves the component objects arranged on a competitor moving line existing in a moving direction of the moving line for the predetermined moving distance in the moving direction, so as to push out the component objects by the moving line, at the competitor's collective body; and a move-result process portion which, after the moving line and the competitor moving line moving, while executing processes relating to a score of the player based on a state of the player's collective body, executes processes relating to a score of the competitor based on a state of the competitor's collective body including the one out of the component objects arranged on the moving line which has moved into the competitor's collective body.

According to the second game machine of the present invention, by the collective body display portion, the player's collective body and the competitor's collective body are displayed so as to be adjacent to each other in the game image. Each collective body is constituted by plural lines and plural columns where a plural kinds of component objects are arranged. By the move process portion, while the moving line in the player's collective body moving depending on the operation by the player, also in the competitor's collective body, the competitor moving line moves. Then, by the move result process portion, the process related to the points of each of the player and the competitor is executed based on the state of each collective body after the moving line moving. By this move, the component object which moves into the competitor's collective body, out of the component objects arranged on the moving line in the player's collective body, affects the competitor's score by being treated as the component object constituting the competitor's collective body. Accordingly, it is possible to make the operation by a player affect, not only the player's collective body, but also the competitor's collective body, and it is possible to reflect the result of the affection in the competitor's score.

Each collective body may be set by the collective body setting portion at the moment of starting the game, or set in each turn (an operation order) in a case where a turn-based game is executed. For example, in a case where two battling players operate one game machine alternately, the collective body setting portion may be configured such that, in each turn, the player to be allowed to operate the game machine is treated as the player of the present invention, and the other player is treated as the competitor. The moving line and the moving distance may be determined based on the operation by the player, may be determined based on some elements not related to the operation by the player for moving the moving line, or may be set as a constant value in advance. Additionally, the present invention include a case where the line direction and the column direction are perpendicular to each other, and a case where the line direction and the column direction are not perpendicular. The number of component objects in the line direction and the number in the column direction may be equal to each other, or may be not equal.

The move process portion may have a moving line determination portion which determines the predetermined moving line by a position determination operation by the player; and may move the component objects arranged on the moving line determined for the predetermined moving distance. Thereby, it is possible to allow the player set his/her desired line as the moving line. Specifically, for example, the moving line determination portion may display in the game image a position specifying symbol travelling as indicating each of the plural lines constituting the player's collective body, and may determine as the moving line, a line indicated by the position specifying symbol at the moment when the position determination operation is performed by the player.

Moreover, the move process portion further may have a moving distance determination portion which determines the predetermined moving distance with respect to the moving line determined by the moving line determination portion depending on a moving distance determination operation by the player, and may move the moving line determined for the moving distance determined. Thereby, it is possible to allow the player set his/her desired moving distance. Specifically, for example, the moving distance determination portion may determine the moving distance, depending on the number of times that the moving distance determination portion has been performed within a predetermined interval.

The game machine may further comprise a communication portion which communicates data with another game machine operated by the competitor, wherein the collective body setting portion may set the player's collective body and the competitor's collective body at a moment when the game starts, the game control portion may have a move information process portion which transmits to the other game machine, move information including moving line information indicating at least one moving line determined by the moving line determination portion and moving distance information indicating the moving distance determined by the moving distance determination portion, and obtains the move information of the competitor from the other game machine, and the move process portion, when obtaining the move information of the competitor from the other game machine, while moving for the moving distance indicated by the moving distance information in a direction of the player's collective body, the plural component objects arranged on the moving line indicated by the moving line information in the competitor's collective body, may move for the moving distance, the plural component objects arranged on a line existing in the moving direction of the moving line in the player's collective body.

Thereby, it is possible to communicate data between the game machines. Accordingly, it is possible to provide a battle game where the other player operating the other game machine is set as the competitor.

The move result process portion, when the component objects establishing a predetermined specific state occur in each of the collective bodies after the moving line moving, may delete the component objects establishing the specific state, may move the component objects arranged in the column direction with respect to each of the deleted component objects so as to fill up a position where the component object is deleted, and may give points to the player or the competitor based on the specific state occurred in each collective body.

Thereby, it is possible to provide a game where the component objects of the generated specific state are deleted in the collective body after the moving line moving. The point includes a plus point and a minus point. The game may be configured such that the specific state originates the plus point and the minus point.

The game machine may further comprise a storage portion which stores supply component object information with respect to the component objects to be supplied to the player's collective body, and supply component object information with respect to the component objects to be supplied to the competitor's collective body, wherein in each supply component object information, the kinds of the component objects may be set, for each column of the corresponding collective body, in an supplying order that the component objects are supplied, the collective body display portion may supply the component object in the supplying order set in the supply component body information for the player to a position where a space has occurred in the player's collective body, and supply the component object in the supplying order set in the supply component body information for the competitor to a position where a space has occurred in the competitor's collective body.

Thereby, as new component objects are supplied to the area which changes into a space based on the deletion of the component objects, it is possible to maintain the shape of the collective body.

The game control portion may further have an operation order specifying portion which sequentially specifies, out of plural users, a user whose operation turn has come as the player, wherein the collective body display portion may display in the game image, the collective bodies corresponding to the plural users so as to be adjacent to each other in the column direction or the line direction; the corrective body setting portion may set as the player's collective body, the collective body corresponding to the user whose operation turn has come out of the collective bodies corresponding to the plural users, and set the collective body adjacent to the player's collective body as the competitor's collective body, the move process portion, in a case that the player's collective body and the competitor's collective body are adjacent to each other in the column direction, may move the moving line and the competitor moving line, by regarding the column direction as the line direction in a process of a case that the player's collective body and the competitor's collective body are adjacent to each other in the line direction, the move result process portion may execute the process relating to the score of the player and the process relating to the score of the competitor independently, by regarding the column direction and the line direction in a process for a case that the player's collective body and the competitor's collective body are adjacent to each other in the column direction as the line direction and the column direction in a process of a case that the player's collective body and the competitor's collective body are adjacent to each other in the line direction respectively.

Thereby, even if there are not less than three users, it is possible to realize the battle game by making the collective bodies corresponding to the users adjacent to each other in the column direction or the line direction. Even if the player's collective body and the competitor's collective body are adjacent to each other in the column direction, it is enough that the processes similar to the ones in a case of being adjacent in the line direction are executed, by treating the column direction as the line direction in a case where the collective bodies are adjacent in the line direction. The maximum number of collective bodies which can be adjacent to each collective body is 3. Which one of the collective bodies is set as the competitor's collective body may be determined based on predetermined conditions or random numbers. It is enough that a correlated relation between each user and his/her collective body is stored in a predetermined storage area.

The move process portion may have a moving line determination portion which determines the predetermined moving line by a position determination operation performed by the player, and may move for the predetermined moving distance, the plural component objects arranged on the determined moving line. Thereby, it is possible to determine the moving line based on the operation by the player (the user whose turn has come).

The move process portion may further have a moving distance determination portion which determines the predetermined moving distance with respect to the moving line determined by the moving line determination portion by a moving distance determination operation performed by the player, and may move the determined moving line for the determined moving distance. Thereby, it is possible to determine the moving distance based on the operation by the player (the user whose turn has come.)

The game system may further comprise a communication portion which communicates data with at least one other game machine, wherein the game control portion may have a move information process portion (10e) which, when the user operating the game machine being specified as the player, transmits to the at least one other game machine, move information including moving line information indicating the moving line determined by the moving line determination portion and moving distance information indicating the moving distance determined by the moving distance determination portion, and when the user operating any one of the other game machines being specified as the player, obtains the move information of the specified user from the other game machine. Thereby, it is possible to execute the battle game with plural users operating the other game machines.

The collective body display portion may display the plural collective bodies arranged successively in a predetermined direction, the operation order specifying portion may specify as the player, the user corresponding to each collective body in an order that the plural collective bodies are arranged, and the collective setting portion may set as the competitor's collective body, the collective body adjacent to the player's collective body in the predetermined direction out of the plural collective bodies. Thereby, as the collective body adjacent to the player's collective body in the predetermined direction is only one, when the player is specified, the competitor can be also specified automatically.

A computer game program as one aspect of the present invention solves the above problems by being configured as a computer game program for a game machine comprising: an operation input portion which accepts operations performed by a player; a game control portion which controls a game; and a display portion which displays a game image of the game, wherein the computer game program is configured so as to make the game control portion function as: a collective body setting portion which sets as the player's collective body, any one of two collective bodies each of which is constituted by plural columns and plural lines where plural kinds of component objects are arranged in a line direction and the column direction, and sets another one of the two collective bodies as a competitor's collective body; a collective body display portion which displays in the game image, the player's collective body and the competitor's collective body so as to be adjacent to each other; a move process portion which, while moving the component objects arranged in a predetermined moving line for a predetermined moving distance in the direction of the competitor's collective body in the player's collective body depending on the operation by the player, in the competitor's collective body, moves for the predetermined moving distance in a moving direction in which the moving line moves, the component objects arranged on a competitor moving line existing in the moving direction, so as to push out the component objects by the moving line; and a move-result process portion which, after the moving line and the competitor moving line moving, while executing processes relating to a score of the player based on a state of the player's collective body, executes processes relating to a score of the competitor based on a state of the competitor's collective body including the one out of the component objects arranged on the moving line which has moved into the competitor's collective body. By running the computer game program of the present invention, it is possible to function a game machine as the second game machine of the present invention.

### Effects of the Invention

As mentioned above, according to the present invention, the moving line determination portion which determines a moving line to be moved out of the plural lines of the collective body constituted by the plural kinds of component objects, the moving distance determination portion which determines depending on the moving distance determination operation performed by a player, the moving distance for which the moving line is moved, and the move execution portion which moves in the collective body, plural component objects on the moving line in the line direction depending on the moving distance are provided. In a case where plural component objects in the post-moved collective body establish a predetermined state, the plural component objects are deleted, and the component objects arranged on the column of the deleted component objects are moved in the column direction. As the move position and the moving distance in the collective body are determined depending on the operation by the player, it is possible to provide the first game machine and the like configured such that the activity is enhanced in a game where points are gained depending on the state of plural kinds of component objects piled up in a game image.

Additionally, the second game machine and the like comprise the collective body display portion which displays two collective bodies in each of which plural kinds of component objects are arranged in a matrix-shape so as to be adjacent to each other in the line direction, the collective body setting portion which sets one of the two collective bodies as the player's collective body and another of them as the competitor's collective body, the move process portion which, while moving the moving line of the player's collective body toward the competitor's collective body in replay to the operation by a player, together with this move, moves the competitor moving line of the competitor's collective body, and the move result process portion which, after the moving line moving, calculates player's score based on the state of the player's collective body, and calculates competitor's score based on the state of the competitor's collective body. Thereby, it is possible to provide the second game machine and the like which are configured such that an operation by a player affects not only the player's component objects, but also the competitor's component objects in a game where points are gained depending on the state that the plural component objects are piled up.

### BRIEF DESCRIPTION OF DRAWINGS

FIG. 1 is a diagram showing a position determination image in one embodiment of a game to be executed by the first game machine of the present invention.

FIG. 2 is a diagram showing a shot image in one embodiment of a game to be executed by the first game machine of the present invention.

FIG. 3 is a diagram showing a blinking image in one embodiment of a game to be executed by the first game machine of the present invention.

FIG. 4 is a diagram showing a ball deletion image in one embodiment of a game to be executed by the first game machine of the present invention.

FIG. 5 is a diagram showing one example of a hardware configuration of the first game machine of the present invention.

FIG. 6 is a flow chart showing a process flow in a game process.

FIG. 7 is diagram showing a process flow executed in a shot process.

FIG. 8 is a diagram showing one example of a hardware configuration of the game machine permitting a battle game with the other game machine.

FIG. 9 is a diagram showing a battle image in the battle game.

FIG. 10 is a flowchart showing a process flow in the battle process.

FIG. 11 is a diagram showing as the first embodiment, one example of a game system constituted by the second game machines of the present invention.

FIG. 12 is a diagram showing one example of a game image for the game executed in the first embodiment of the second game machine.

FIG. 13 is a diagram showing a kick condition determination image for determining a moving line.

FIG. 14 is a diagram showing a kick image where the moving line moves by a soccer ball.

FIG. 15 is a diagram showing a state that the balls in a specific state in the ball mass are blinking.

FIG. 16 is a diagram showing an outline of hardware configuration of the second game machine in the first embodiment.

FIG. 17A is a diagram showing one example of player information held by the second game machine in the first embodiment.

FIG. 17B is a diagram showing one example of competitor information held by the second game machine in the first embodiment.

FIG. 18 is a flow chart showing a process flow in a battle game process.

FIG. 19 is a flow chart showing a process flow in a kick condition determination process.

FIG. 20 is a flow chart showing a process flow in a kick process.

FIG. 21 is a diagram showing a kick image which is displayed in a case that the competitor's turn has come.

FIG. 22 is a diagram showing a kick condition determination image which is displayed at the competitor's game machine in a case that the competitor's turn has come.

FIG. 23 is a diagram showing a kick image which is displayed at the competitor's game machine in a case that the competitor's turn has come.

FIG. 24 is a diagram showing a game image in a case that the battle game is executed by one of the second game machine in the first embodiment.

FIG. 25 is a flow chart showing a process flow in a battle game process in the case of FIG. 24.

FIG. 26 is a diagram showing as the second embodiment, one example of a game system constituted by the second game machines of the present invention.

FIG. 27 is a diagram showing a game image in the second embodiment.

FIG. 28 is a diagram showing a kick image in the case where two ball masses are adjacent to each other in the line direction in the second embodiment.

FIG. 29 is a diagram showing a result state of the two ball masses after a ball being kicked in the case of FIG. 28.

FIG. 30 is a diagram showing a kick image in the case where two ball masses are adjacent to each other in the column direction in the second embodiment.

FIG. 31 is a diagram showing a result state of the two ball masses after a ball being kicked in the case of FIG. 30.

### DESCRIPTION OF EMBODIMENTS

1. First Game Machine

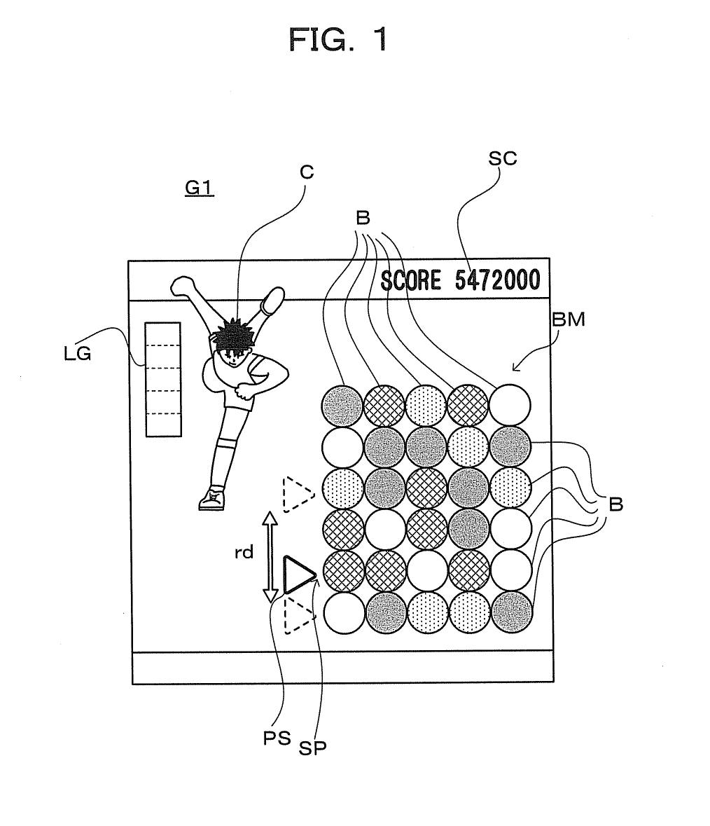

FIGS. 1 to 4 shows one example of game images G1 to G4 for a game to be executed by a first game machine of the present invention (in what follows, referred to as “the game machine” in this section). In what follows, when it is not necessary to distinguish each of the game images G1 to G4, the game images are referred to as “the game image G”. The game of the present invention is a so-called falling objects puzzle game. A character C is controlled so as to shoot a soccer ball SB to a ball mass BM constituted by balls B which are arranged in 5 columns×6 lines. Thereby, The line of the shot position SP (hereinafter, referred to as “the shot line”) is moved, and in the ball mass BM after the shot line moving, a ball group CP which satisfies a ball deletion condition is deleted. By moving down the ball group BG2 existing above the ball group CP, the ball mass BM is broken. In the present embodiment, as plural kinds of balls, three different color balls are prepared. The deletion condition is that three balls having the same color are arranged sequentially in a line or an L-letter shape. By the deletion of the ball group CP, a predetermined points are gained, and the player's score displayed at the top part in the game image G is increased.

In what follows, the construction of the game will be explained concretely. The direction parallel to the column of the ball mass BM is referred to as the column direction rd. The column direction rd is a vertical direction (an up-down direction) with respect to the game image G. The direction parallel to the line of the ball mass BM is referred to as the line direction 1d. The line direction 1d is a horizontal direction (a left-right direction) with respect to the game image G. The ball B is set so as to move downward with respect to the column direction rd, and move rightward with respect to the line direction 1d.

Firstly, in the position determination image G1 (FIG. 1), a player is allowed to determine the line of the shot position SP, that is, the shot line. In the position determination image G1, the ball mass BM and the character C on the left side thereof are displayed, and the position specifying symbol PS is further displayed on the character C's side with respect to the ball mass. The position specific symbol PS is reciprocating in the column direction rd at a predetermined speed, as indicating each of the first to the sixth lines of the ball mass BM. Then, At the moment when the position determination operation has been performed by the player, the line indicated by the position specifying symbol PS is determined as the shot position SP. As the position determination operation, for example, pressing down a predetermined position determination key is enough. In the present invention, a case where the fifth line is determined as the shot line is described.

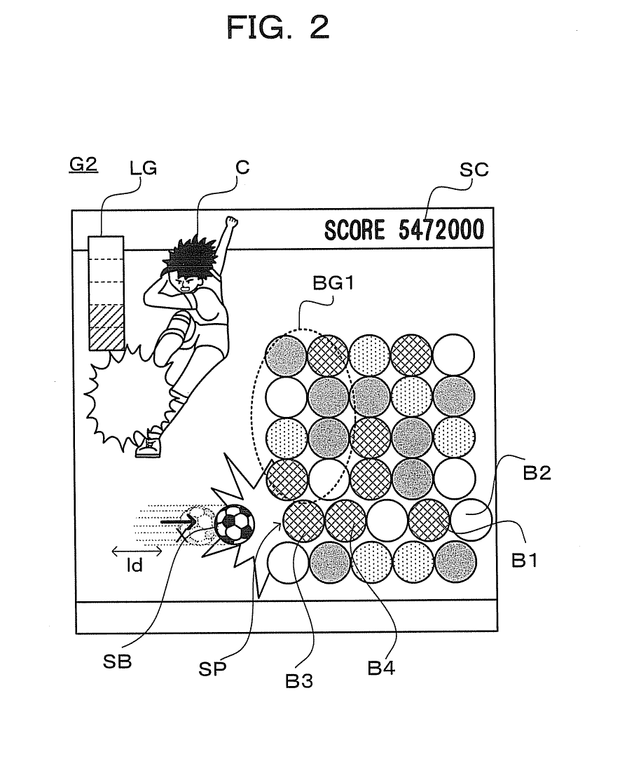

After determining the shot position SP, when a shot operation is performed by the player subsequently, as shown in a shot image G2 (FIG. 2), a state where the character C kicks the soccer ball SB and the soccer ball SB is shot to the shot line is displayed. By shooting the soccer ball SB, the balls B arranged in the shot line moves in a shot direction X parallel to the line direction 1d. As the shot operation, pressing down a predetermined shot determination key is enough. In the present embodiment, in accordance with the number of times the shot operation is performed, a shot power can be changed from level 1 to level 5 in a stepwise fashion. For example, in the case when the shot operation is performed once, the shot power is set to level 1, which means that a moving distance of the shot line is one-ball distance. In the case when the shot operation is performed twice, the shot power is set to level 2, which means that a moving distance of the shot line is two-ball distance. The state that the shot power changes in accordance with the number of times the shot operation is performed is displayed in a level gauge LG.

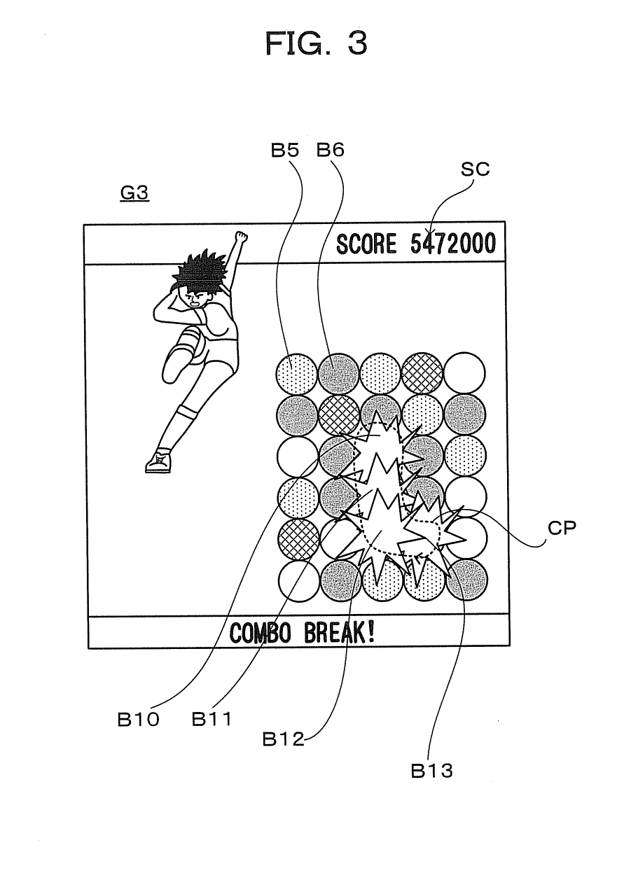

In the present embodiment, a case where the shot operation has been performed twice is described. Thereby, the shot power is set to level 2, and the five balls B arranged in the shot line move for two-ball distance in the shot direction X. In this case, the two balls B1,B2 arranged in the not shot side of the shot line are pushed out of the ball mass BM and deleted. As the part where the balls B3, B4 at the shot side have existed changes into a space are by the move of the shot line, the ball group BG existing above the space area moves down so as to fill up the space area. Additionally, to each part which becomes a space area (the first line first column, and the first line second column) by the drop of the ball group BG, as the blinking image G3 (FIG. 3), the ball mass BM is replenished with new balls B5,B6.

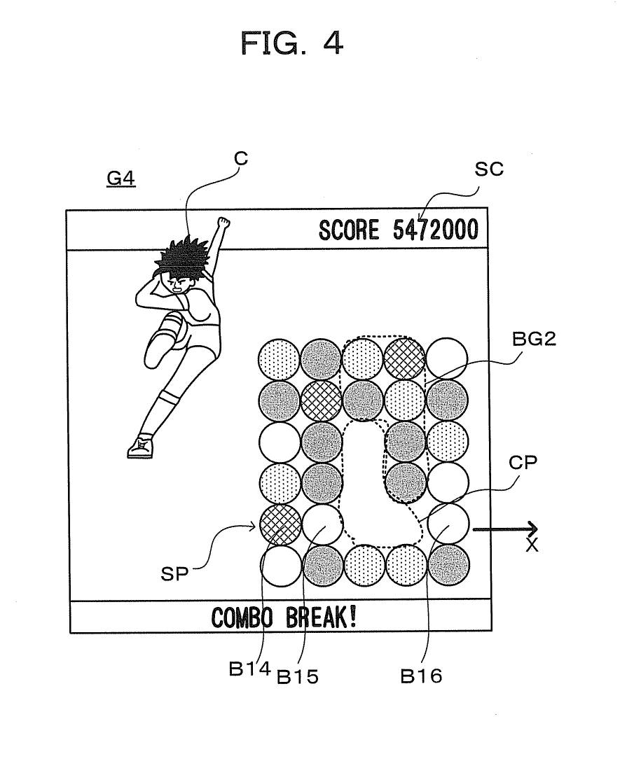

In this state, it is determined whether the deletion condition of ball B is satisfied or not, and the balls B10 to B13 satisfying the deletion condition starts blinking. Hereinafter, the state which the deletion condition is satisfied is referred to as “the clear state”, and the plural balls B in the clear state referred to as “the clear part CP”. After the clear part CP blinking, as shown in the ball deletion image G4 (FIG. 4), the balls 810 to B13 included in the clear part CP are deleted, and the clear part CP changes into a space. The ball group BG2 existing above the clear part CP which has changed into a space area moves down, that is, drops so as to fill up the clear part CP.

In the present embodiment, after the balls B10 to B13 in the clear state blinking and before the ball group BG dropping, if a consecutive shot operation is performed by the player, it is possible to make the character C make a consecutive shot to the shot line with the soccer ball SB. By the consecutive shot, it is possible to move the balls B14 to B15 remaining in the shot line for one-ball distance in the shot direction. After making the consecutive shot, the blinking of each ball B which has changed into the clear state, the deletion after the blinking, and the acceptance of the consecutive shot are repeated. Then, in the case where no clear state exists or in the case where the consecutive shot is not made, one turn with respect to shot started from the determination of the shot position SP is terminated. As the consecutive shot operation, pressing down a predetermined consecutive shot determination key is enough. In the preset embodiment, the shot power of the consecutive shot is a fixed level (for example, level 1).

When one turn is terminated, in order to restore the ball mass BM in the state of 6 lines×5 columns, new balls are supplied from the top, and the acceptance of the position determination operation is started for a shot of the next turn. After that, the processes in the turn are repeated. Then, when all of the soccer balls SB (in the present embodiment, 100 pieces) held by the character C, or when new balls B to be supplied to the ball mass BM have run out and all of the balls B of the ball mass BM have been deleted, the game is terminated.

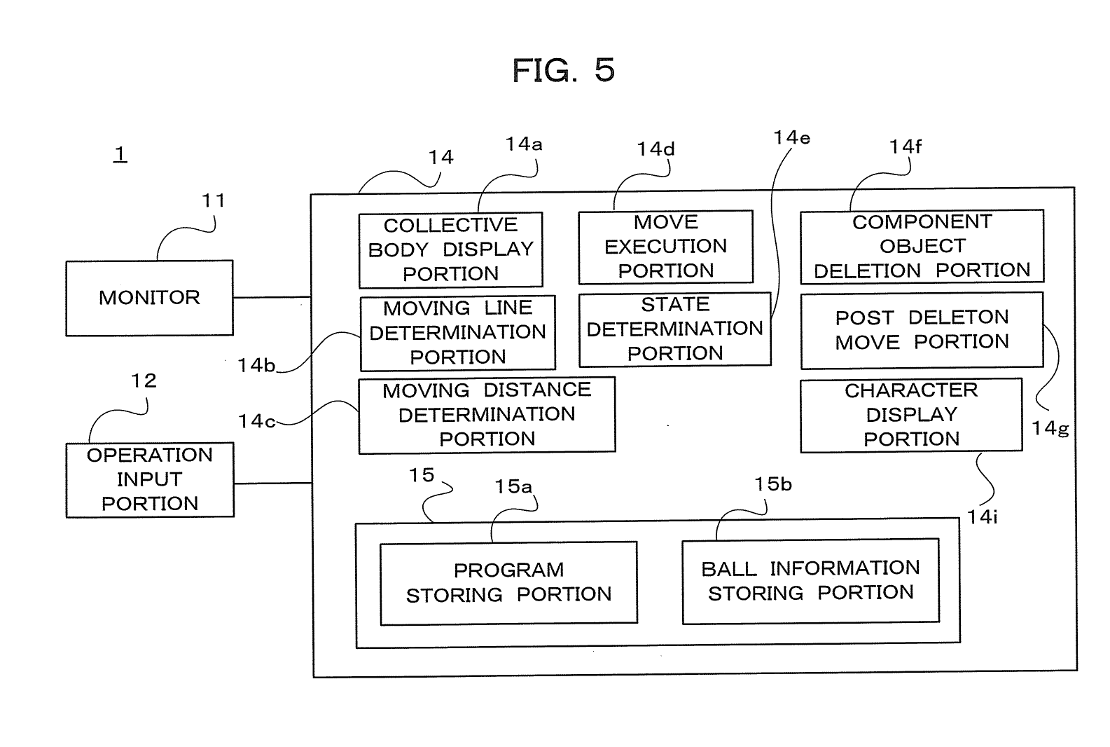

Hereinafter, the concrete configuration of the game machine 1 of the present invention to execute the above mentioned game, and the process controlled by the game machine 1 will be described. The hardware configuration of the game machine 1 of the present embodiment comprises, as shown in FIG. 5, a monitor 11 which displays the game image G, an operation input portion 12 which includes various keys to accept operations by the player, and a game control unit 14 which controls the progression of the game. The game control unit 14 comprises a CPU and a memory area 15 such as a RAM, ROM and the like necessary for operations of the CPU, and various timers. The memory area 15 includes a program storing portion 15a where a game program for making the game machine 1 operate as a game machine of the present invention is stored, and a ball information storing portion 15b where ball information is stored, the ball information having information with respect to the balls B to constitute the ball mass BM.

By starting the game program in the program storing portion 15a, the game control unit 14 functions as mainly a collective body display portion 14a, a moving line determination portion 14b, a moving distance determination portion 14c, a move execution portion 14d, a state determination portion 14e, component object deletion portion 14f, a post deletion move portion 14g, and a character display portion 14i. The function of each of the portions 14a to 14i will be described later.

In the ball information storing portion 15b, the ball information is stored. In the ball information, the color of each ball B to appear and the appearing order as the order that the ball B is displayed in the monitor 11 are set for each column of the ball mass BM. At the moment of starting the game, by the collective body display portion 14a, the balls B, their appearing orders set in the ball information are from the first appearing order up to the sixth appearing order, are arranged in each of the first to sixth lines of each column in the ball mass BM. After that, when the component object in any one of the column moves down, in order to restore the ball mass BM having balls arranged in 6 lines×5 columns, the ball B, the color of which follows the appearing order, is supplied in sequence to the upper portion of the column where the component object has moved down.

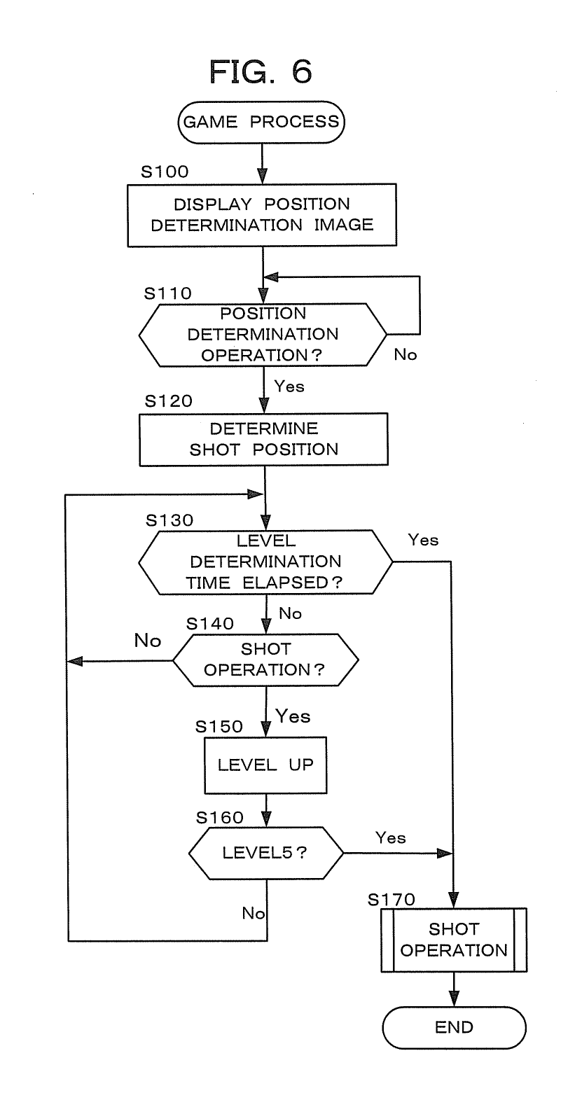

The game process which is executed by the game control unit 14 will be described by following flow charts shown in FIGS. 5 and 6. The game process is executed each time when each turn is started in the game. Firstly, in step S100, the position determination image G1 is displayed in the monitor 11, and in step 110, a waiting state of position determination operation by a player starts. In the position determination image G1, as mentioned above, the ball mass BM constituted by the component objects arranged in 5 columns×6 lines is displayed, and the character C is displayed on the left side of the ball mass BM. In order to display the ball mass BM, it is enough to specify the colors corresponding to the appearing orders 1 to 6, by referring the ball information with respect to each of the columns 1 to 5, and arrange the ball B having the color specified in each line of each column. Thereby, the game control unit 14 functions as the collective body display portion 14a and the character display portion 14i.

Additionally, the position specifying symbol PS is controlled so as to be displayed on the character C's side with respect to the ball mass BM and moved in the column direction rd. When an affirmative determination is obtained in step S110, the process goes to step S120 to determine as the shot position S, the line which the position specifying symbol PS is indicating at the moment when the operation is performed. Thereby, the game control unit 14 functions as the moving line determination portion 14b. In the position determination image G1, it is preferable that the character C is represented in a pose for shot by the character display portion 14i.

Subsequently, the process goes to step S130 to determine whether the level determination period has elapsed or not. The level determination period is the maximum time period (in the present invention, 0.5 seconds) that a shot operation can be accepted as an operation for determining the level of shot power. After the shot position is determined, a level determination timer for counting the level determination period starts counting time, the process of step S130 is determined based on this timer. When an affirmative determination is obtained in step S130, it means that the shot operation for determining the level of shot power has not been performed in the maximum time period. The process determines the power of shot as the level at the moment, and goes to step S170 to execute the shot process. Thereby, the game control unit 14 functions as the moving distance determination portion 14c. In the shot process, the processes from shooting the soccer ball SB up to reflecting the result of shot in the score are executed. The detail of shot process will be described later.

When a negative determination is obtained at step S130, the process goes to step S140 to determine whether the shot operation has been performed or not. When a negative determination is obtained at step S140, the process returns to step S130. When an affirmative determination is obtained at step S140, the process goes to step S150 to increase the level of the shot power by one. In reply to increase of the level, the display of the level gauge LG is also updated. In this way, by making the player perform the shot operation at not more than 0.5-second intervals, that is, the player performs the shot operation sequentially, the level is determined in accordance with the number of times the shot operations is performed. The maximum level is level 5. the player can set his/her demanding level based on the state of the ball mass BM. The default value of the level of shot power is zero.

Next, the process goes to step S160 to determine whether the shot power has reached level 5 or not. At step S160, a negative determination is obtained, the process returns to step S130 to determine whether the level determination period has elapsed or not. Once the shot operation is performed, the level determination timer starts counting the level determination period each time when the shot operation is performed. When an affirmative determination is obtained, it means that as the current shot power is the maximum, the level does not increase any more, and the process goes to the shot process at step S170. The shot process will be described later. After the shot process, the game process is terminated.

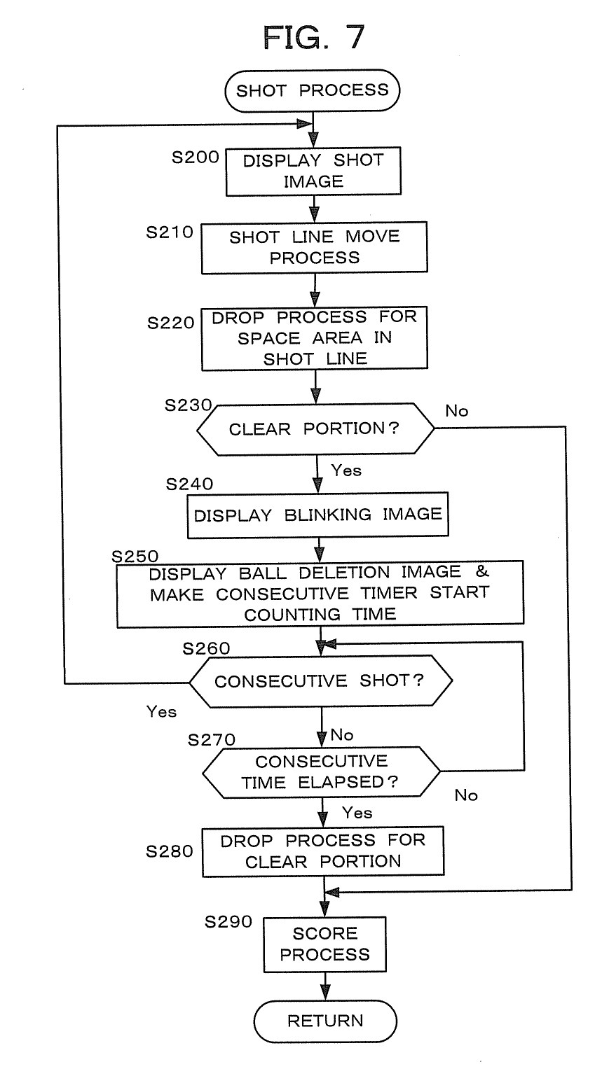

The processes executed in the shot process will be described by following a flow chart shown in FIG. 7. Firstly, at step S200, the shot image G2 is displayed. In the shot image G2, the character display portion 14i displays the state that the character C is shooting the soccer ball SB toward the shot position SP. Subsequently, the shot line move process is executed at step S210. In the shot line move process, the balls B on the shot line are controlled so as to move for a moving distance depending on the level of the shot power. For example when the shot power is level 2, the balls B are controlled so as to move for two-ball distance. Thereby, the game control unit 14 functions as the move execution portion 14d. By this move, the balls B1, B2 protruded out of the ball mass BM are controlled so as to be deleted in the shot image G2.

Next, at step S220, the drop process is executed for the space area in the shot line which has been generated by the move of the balls B. In the drop process, the ball group BG1 existing above the space area is controlled to move down so as to fill the space area. To the top line of the ball mass BM where a space area is generated by this drop, the new balls B5, B6 are dropped from the top of game image G and supplied to the ball mass BM. Thereby, the game control unit 14 functions as the collective body display portion 14a. In the present embodiment, by referring the ball information corresponding to each of the first column and the second column, the colors of the balls B which should appear next are specified, and each of the balls B5, B6 having the specified color is represented so as to be supplied to the corresponding column. Next, at step S230, it is determined whether there is the clear portion CP or not. Thereby, the game control unit 14 functions as the state determination portion 14e. When a negative determination is obtained at step S230, the process goes to step S290, and when an affirmative determination is obtained, the process goes to step S240.

At step S240, the blinking image G3 is displayed by blinking the clear portion CP. After that, the process goes to step S250. At step S250, the plural balls B constituting the clear portion CP are deleted to display the ball deletion image G4, and the consecutive timer starts counting time. Thereby, the game control unit 14 functions as the component object deletion portion 14f. The consecutive timer is a timer which counts a consecutive time that consecutive shot can be accepted. Subsequently, at step S260, it is determined whether the consecutive shot has been performed or not. When an affirmative determination is obtained at step S260, the process returns to step S200, and when a negative determination is obtained, the process goes to step S270. At step S270, it is determined whether the consecutive time should end or not. When a negative determination is obtained, the process returns to step S260.

When an affirmative determination is obtained in step 270, the process goes to step S280, and a falling process with respect to the clear portion CP which has changed to a space is executed. In the falling process, the ball group BG2 arranged above the clear portion CP is moved downward so as to fill up the space of clear portion CP. Thereby, the game control unit 14 functions as the post deletion move portion 14g. For the space portion in the top portion of the ball mass BM which is caused by the falling, new balls are supplied from the top of the game image G and the shape of ball mass BM having 5 columns×6 lines balls is restored. With respect to each of the new balls, by referring the ball information corresponding to each of the third and fourth columns, the color of each ball B which should appear in each of the columns is specified by following the appearing order. Then, it is enough that the balls B each having the specified color are supplied from the top of the game image G. Thereby, the game control unit 14 functions as the collective body display portion 14a.

Next, the process goes to step S290 to execute a score process. In the score process, the points corresponding to the clear portion CP occurring in the current turn and the points corresponding to the operation are added to the player's score SC. After the score process, the shot process is terminated.

The present invention is not limited to the above mentioned embodiment, and can be executed in various embodiments. For example, in the above embodiment, the character C is located on the left side of the ball mass BM, the game can be configured so that the character C is located on the right side of the ball mass BM and makes a shot toward the right side. Also in this case, the game process is similar to the above mentioned game process, but the motion of the character, the display position of the position specifying symbol PS and the shot direction in the shot process are symmetric to them in the above embodiment. Additionally, the game may be configured so that during the game, the character C can be located on the left side or the right side depending on an operation by the player and the character C can make a shot toward the ball mass BM.

Moreover, it is not necessary that the column direction rd of the ball mass BM and the line direction 1d of the ball mass BM are at right angles to each other. It is not necessary that the ball mass BM is constituted by the balls B, and the collective body formed by plural component objects arranged in plural columns and plural lines can be applied. The game image can be configured so that the character C is located on the destination side of the shot line and a state that the character C is pulling the shot line is displayed. The game may be configured so that the player is allowed to press a predetermined key for a while as the moving distance determination operation, and the moving distance is determined in accordance with the duration of pressing the key.

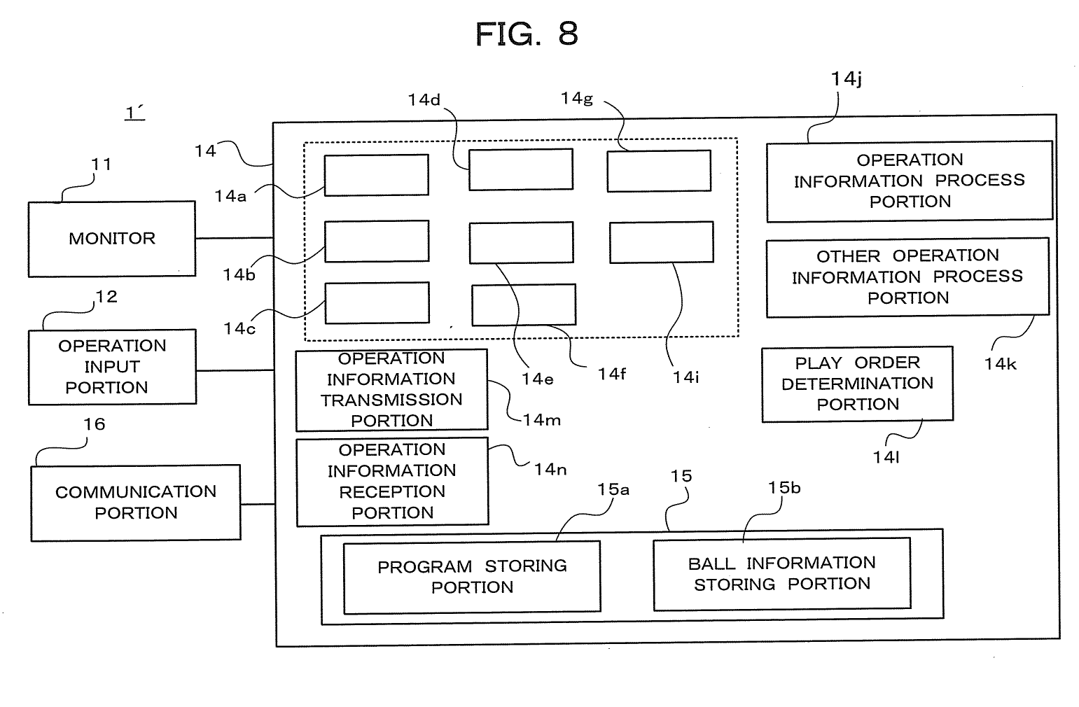

Moreover, as shown in FIG. 8, the game machine 1′ of the present invention, besides the configuration of the game machine 1, further includes a communication portion 16 by which a data communication with the other game machine 1′ is allowed. Thereby, for example, it is possible to execute a battle game with another player (hereinafter, referred to as “the competitor”), where the players play the game alternately for each turn. The game control unit 14 in the game machine 1′ functions as the operation information process portion 14j, the other operation information process portion 14k, the play order determination portion 14l, the operation information transmission portion 14m and the operation information reception portion 14n, besides each of the portions 14a to 14i of the game control unit 14 in the game machine 1. The process in each of the portions 14j to 14n will be described later.

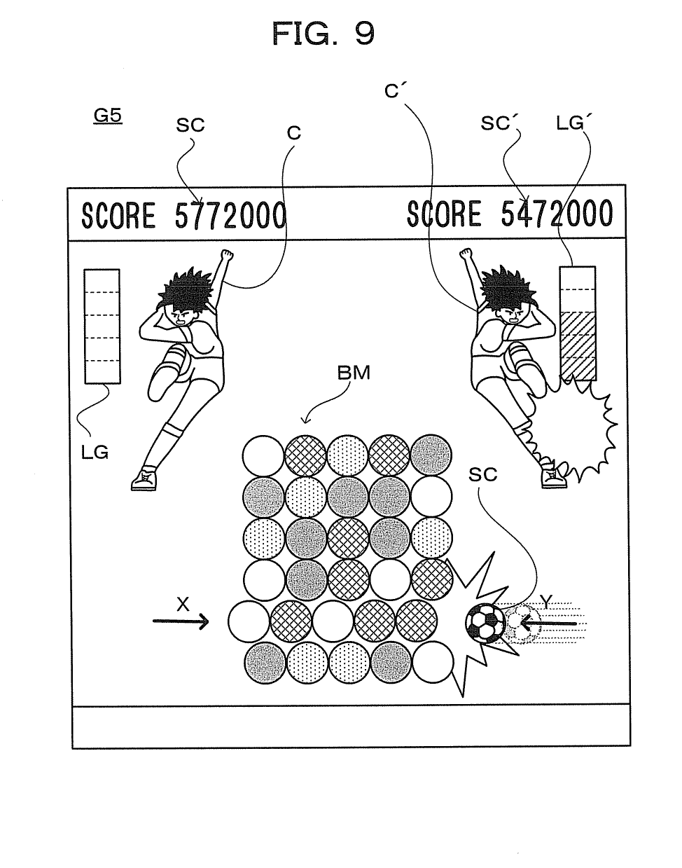

As shown in FIG. 9, in a battle image G5 which is the game image in the battle game, the character C′, the level gauge LG′ and the score SC′ belonging to the competitor corresponding to the character C, the level gauge LG and the score SC belonging to the player are displayed symmetrically across the ball mass BM. The player can control his/her character C so as to make a shot from the left side of the ball mass BM in the shot direction X in the player's turn by the above mentioned game process. On the other hand, the competitor can control the character C′, by the game process to be executed in the competitor's turn, so as to make a shot from the right side of the ball mass BM in the shot direction Y. The motions at the moment of shooting of the character C and the character C′ are symmetrically displayed.

FIG. 9 shows a state that the character C′ is shooting in the shot direction Y in the battle image G5. In this way, the game machine 1′ provides a battle game where points are gained by shooting to the both sides of the same ball mass BM. Also in the monitor 11 of the game machine 1′ of the competitor, the image which is the same as the battle image G5 is displayed. Namely, in the case of example shown in FIG. 9, the character C′ corresponding to the competitor is displayed at the right side in the monitor 11 of the competitor. Which one of the two players is assigned to which side can be determined suitably by the game control unit 14.

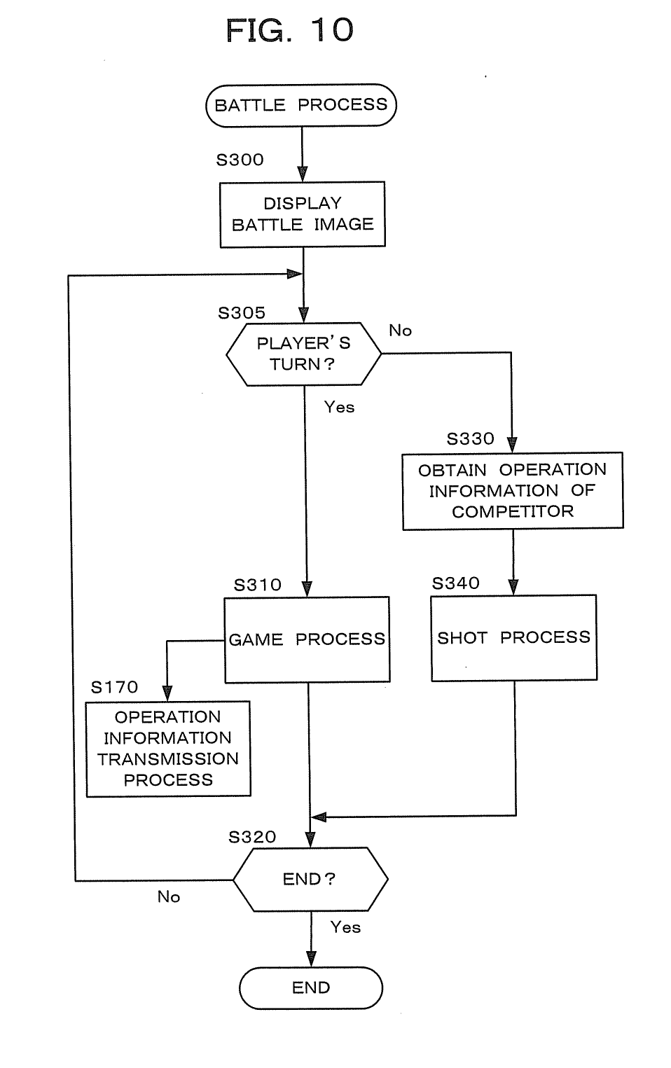

A battle process to be executed by the game control unit 14 in the game machine 1′ will be described, using a flow chart shown in FIG. 10, the battle process being in a case when the character C shown in FIG. 9 is a character corresponding to the player. Firstly, at step S300, the battle image G5 is displayed. As mentioned above, in the battle image G5, the character C and the like belonging to the player are displayed at the left side with respect to one ball mass BM and the character C′ and the like belonging to the competitor are displayed at the right side. The competitor's character C′ may be the same as the player's character C. Alternatively, for example, the character C′ may be a character based on an image of the character C which is obtained by making the competitor transmit the image.

Next, at step S305, it is determined whether the current turn is the player's turn or not. Thereby, the game control unit 14 functions as the play order determination portion 14l. When an affirmative determination is obtained at step S305, the process goes to step S310 and the game process above mentioned is executed to make the character C make a shot. However, at step S170 in the battle process, an operation information transmission process for transmitting operation information to the other game machine 1′ via the communication portion 16 is executed at the same time as the shot process.

The operation information includes the determined shot position SP and the determined level of shot power. Thereby, the game control unit 14 functions as the operation information process portion 14j and the operation information transmission portion 14m. Subsequently, as step S320, it is determined whether the battle game should be terminated or not. It is determined that the battle game should be determined in a case where all of the balls B constituting the ball mass BM have been deleted, or all of the soccer balls held by the player or the competitor have been run out. When an affirmative determination is obtained at step S320, the battle process is terminated. A negative determination is obtained at step S320, the process goes back to step S305.

When a negative determination is obtained at step S305, which means that the current turn is the competitor's turn, at step S330 the operation information of the competitor transmitted from the competitor's game machine 1′ is received by the communication portion 16. Thereby, the game control unit 14 functions as the operation information reception portion 14n. Subsequently, the process goes to step S340 and the shot process is executed based on the competitor's operation information received. It is enough that the shot process at step S340 is similar to the shot process above mentioned except the followings: the motion of the character C′ and the shot direction Y are symmetrical to the motion of the character C and the shot direction X respectively, and the points gained at step S290 are added to the competitor's score SC′. Thereby, the game control unit 14 functions as the operation information process portion 14k. The battle game of the present invention can be configured so that the battle process is executed within one game machine 1′, without transmission and reception of the operation information.

2. First Embodiment of Second Game Machine

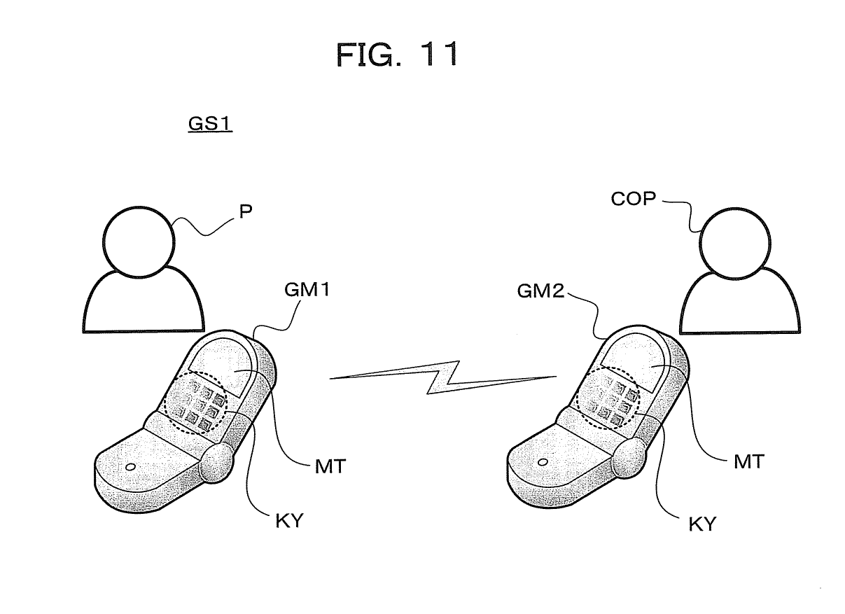

FIG. 11 is a diagram showing an example of game system GS as the first embodiment, the game system GS including the second game machines GM1, GM2 of the present invention (hereinafter, they are referred to as “the game machine GM1, GM2”). The game machine GM1 is operated by a player P, and the game machine GM2 is operated by a competitor COP. The game machine GM1 and the game machine GM2 in the present embodiment communicate data with each other directly using, for example, infrared ray as a carrier wave, but they can be configured so that they communicate data with each other via a predetermined network. Either a wireless communication or a wired communication is applied to this connection form. The game machine GM1, GM2 of the present invention is a portable-type phone having a monitor MT where a game image is displayed and a key portion KY where plural keys to accept data input by the player P or the competitor COP are provided. Hereinafter, when it is not necessary to distinguish between the game machine GM1 and the game machine GM2, they are referred to as “the game machine GM”. It is not necessary that the game machine GM of the present invention is the portable phone, the game machine GM can be a portable computer or desktop computer.

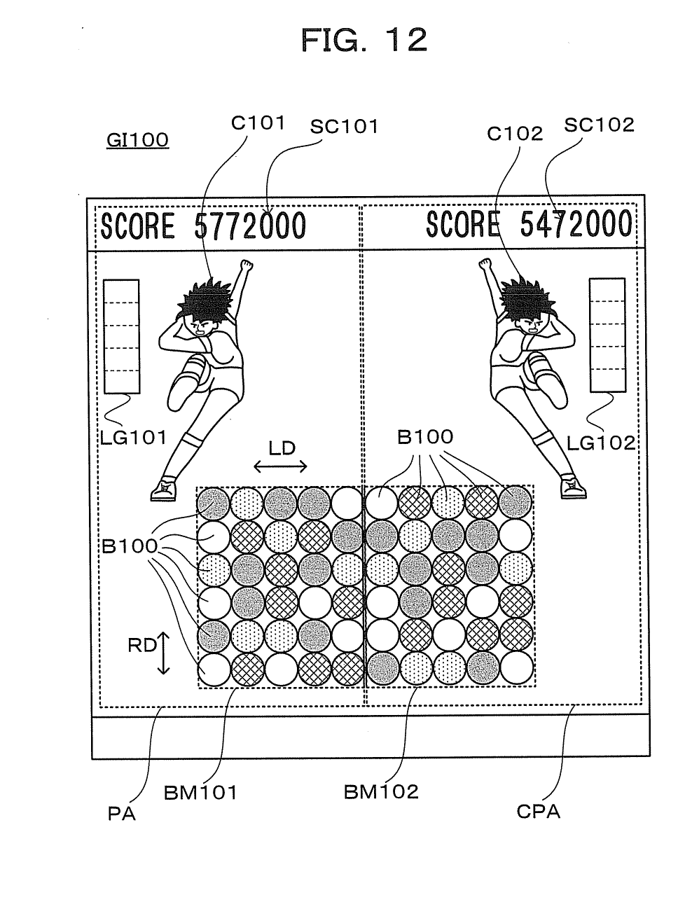

The game to be executed in the game machine GM (hereinafter referred to as “the present game”.) will be described using FIGS. 12 to 15. Firstly, the basic configuration of the game image GI100 for the present game will be described using the game image GI100 to be displayed in the monitor MT of the game machine GM as an example. The game image GI100 comprises a player area PA which is a left half of the game image GI100 and a competitor area CPA which is a right half of the game image GI100. In the player area PA, some information associated with the player are displayed. In the present embodiment, as shown in FIG. 12, a ball mass BM101 as a player's collective body, a character C101, a score SC101 and a level gauge LG101 to indicate a kick power which is telling later are displayed. In the competitor area CPA, some information associated with the competitor COP are displayed. In the present embodiment, a ball mass BM102 as a competitor's collective body, a character C102, a score SC102 and a level gauge LG102 to indicate a kick power which is telling later are displayed.

Hereinafter, when it is not necessary to distinguish between the ball mass BM101 and the ball mass BM102, they are referred to as “the ball mass BM100”. When it is not necessary to distinguish between the character C101 and the character C102, they are referred to as “the character C100”. When it is not necessary to distinguish between the score SC101 and the score SC102, they are referred to as “the score SC100”. When it is not necessary to distinguish between the level gauge LG101 and the level gauge LG102, they are referred to as “the level gauge LG100”.

Each of the ball mass BM101 of the player P and the ball mass BM102 of the competitor COP is located so that they are adjacent to each other in the line direction LD. Each ball mass BM100 is constituted by plural kinds of balls B100 as plural kinds of components. The plural kinds of balls B100 of the ball mass BM100 are arranged in the shape of a of having 5 balls B in the line direction LD and 6 balls B in the column direction RD. Each of the balls B100 which have same shape and same size thereof, can be distinguished to each other in a pattern and color thereof. In the game image GI100, preferably, the information associated with the player P and the information corresponding to the information associated to the competitor COP are symetrically displayed.

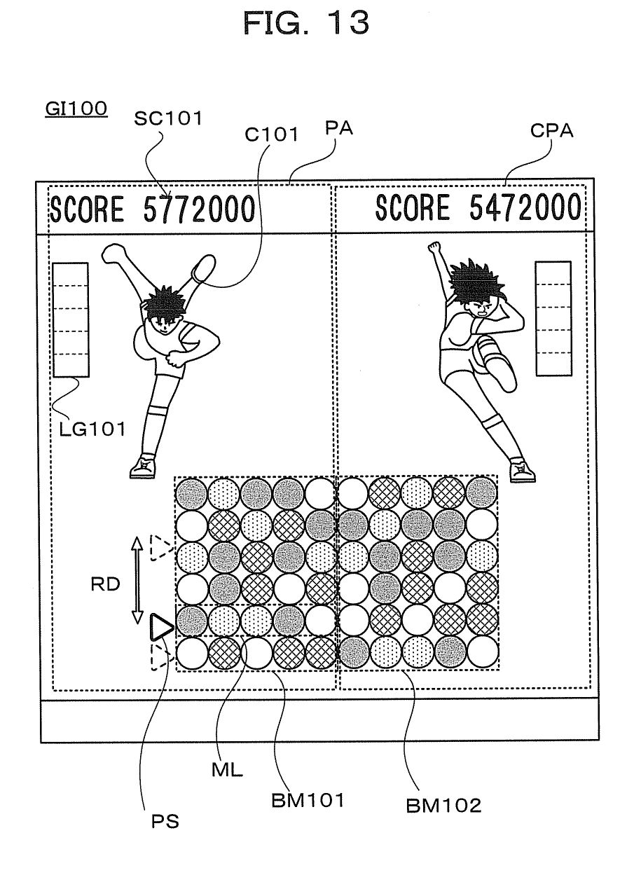

The present game is a battle game in which the players make the character C100 kick a soccer ball in the mentioned game image GI100 to break the ball mass BM100 by the soccer ball kicked, and compete in obtaining the scores SC101, SC102. The present game is a turn-based game, that is, the operation by the player P and the operation by the competitor COP are performed by rotation. At the moment of the player's operation turn, in the game image GI100 as the kick condition determination image, the position specifying symbol PS is displayed at the lateral side of the character C101's side of the ball mass BM101, as shown in FIG. 13. The ball specifying symbol PS reciprocates along the lateral side of the ball mass BM101 in the column direction RD at a predetermined speed, as indicating from the first line to the sixth line. When a predetermined position determination operation is performed to the game machine GM by the player P, in reply to this operation, the position specifying symbol PS stops, and the line indicated by the position specifying symbol PS which has stopped is determined as a moving line ML. When the moving line ML is determined, a state that the character 101 takes a backswing for the kick is displayed. In addition, plural lines including the line indicated by the position specifying symbol PS can be determined as the moving lines ML, or a line having a predetermined relation to the line indicated by the position specifying symbol PS can be determined as the moving line ML.

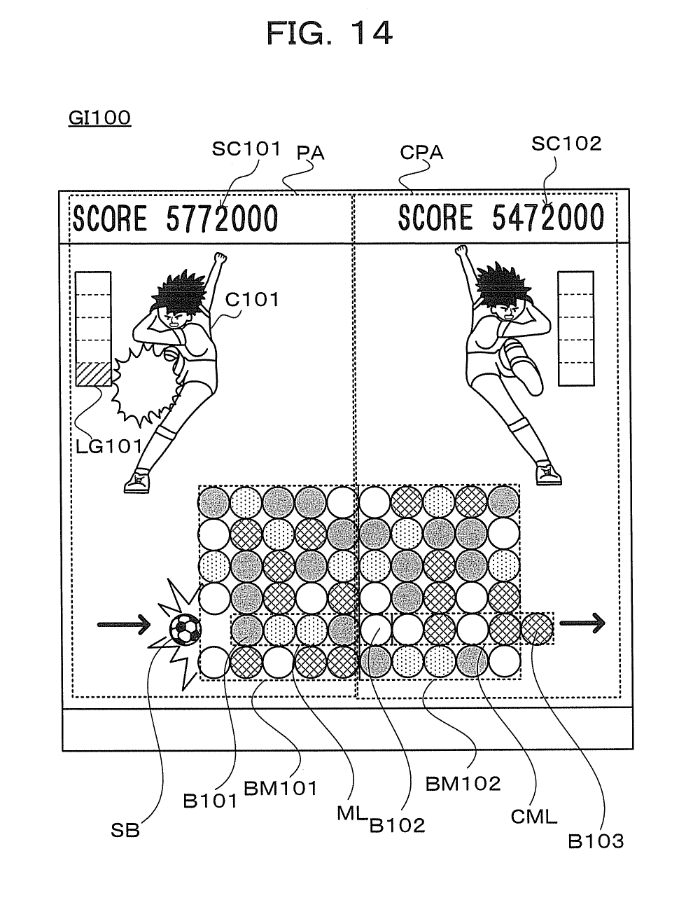

Next, when a kick power determination operation for determining a kick power which is a moving distance is performed to the game machine GM1 by the player P, the kick power is determined. Five levels are prepared as the kick power. In the present embodiment, the level is determined depending on the number of times the kick power determination operation is performed. In the level gauge LG101, the level indicating the determined kick power is displayed. When the kick power is determined, a state that the soccer ball SB is kicked by the character C101 to hit the ball B101 existing at the edge on the character C101's side of the moving line ML is shown, as shown in FIG. 14. The moving line ML which the soccer ball SB has hit moves for the moving distance depending on the determined kick power in a direction to the competitor side (in the present embodiment, the right direction).

With respect to the ball mass BM102 of the competitor COP, the line corresponding to the moving line ML, that is, a competitor moving line CML existing in the moving direction of the moving line ML, is pushed out by the moving line ML to move. As a result, the balls 100 constituting the moving line LM and the competitor moving line CML adjacent thereto move for the moving distance depending on the kick power in the direction to the competitor side. FIG. 14 shows a state that, in a case where the moving line ML is determined as the fifth line of the ball mass BM101, and the kick power is determined as a level of one-ball distance, the moving line ML and the competitor moving line CML move for one-ball distance in the direction to the competitor side. Thereby, the ball B102 existing at the edge on the competitor's side of the moving line ML of the player P moves into the ball mass BM102 of the competitor, and after that, the ball B102 is treated as a ball B100 constituting the ball mass BM102. The ball B103 pushed out of the ball mass BM102 is deleted.

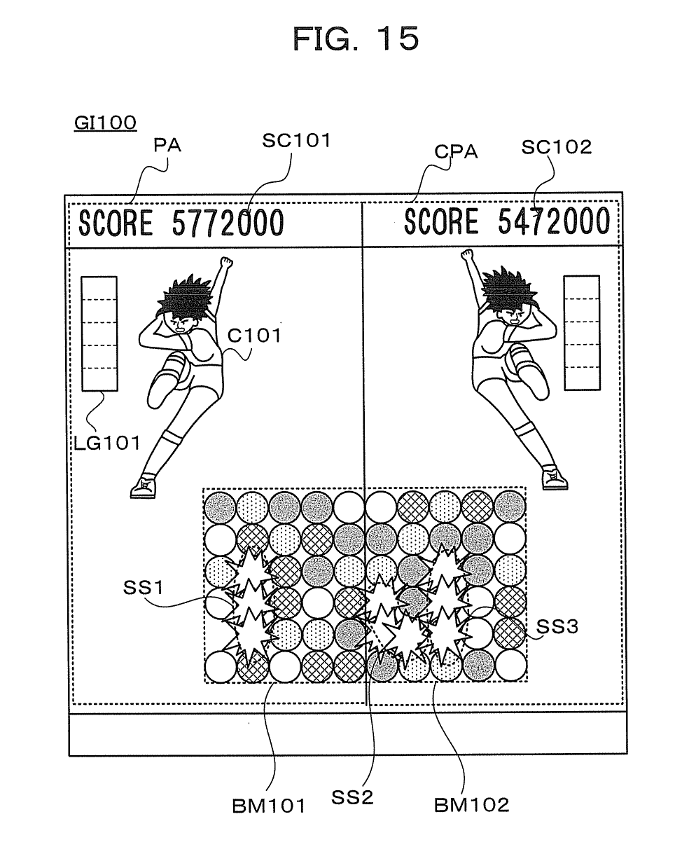

After the moving line ML and the competitor moving line CML move, it is determined whether a specific state occurs in each of the ball masses BM101, BM102. In the present embodiment, the state that three same kind of balls B100 are arranged successionally either in the column direction RD, in the line direction LD or in the shape of the letter “L” is the specific state. In FIG. 15 shows a state that the specific state SS1 occurs in the ball mass BM101, the specific state SS2 and the specific state SS3 occur in the ball mass BM102. Hereinafter, in a case that it is not necessary to distinguish between the specific states SS1, SS2, SS3, they are referred to as “the specific state SS”. For each of the player P and the competitor COP, the sore is calculated depending on the specific state SS, and the scores SC101, SC102 of the player P and the competitor COP are updated respectively.

When the specific state SS occurs, the balls constituting the specific state SS blink, and after that they are deleted. Thereby, the area where the specific state SS has occurred changes to a space area. With respect to the space area, the balls B arranged in the column direction RD above the space area move downward, so that the space area is filled up. New supply balls B100 are supplied so that a space area which has occurred at the top portion of the ball mass BM100 by the balls' move is filled up. It does not matter how the supply balls B100 are supplied to the space area, but it is preferable that they are supplied from the top portion of the game image GI100. Thereby, the state in the ball mass BM100 that the balls B100 are arranged in 6 lines and 5 columns is maintained until the ball B100 is run out. The number of balls B100 corresponding to each of the player P and the competitor COP is constant, and the column to be supplied and the sequence of kind with respect to each supply ball B100 are predetermined.

In addition, in the present embodiment, when a predetermined consecutive kick operation is performed by the player P after the moment when the balls B100 constituting the specific state SS start blinking before the moment when the balls B100 starts moving to fill up the space area, it is possible to further move the same moving line ML by the soccer ball SB. The moving distance of moving line ML by the consecutive kick can be the same as the moving distance of the first kick, or a constant moving distance can be predetermined as the moving distance by the consecutive kick.

On the other hand, at the moment of the competitor COP's operation turn, the competitor COP performs to the game machine GM2 as the player P, the position determination operation and the kick power determination operation, as with operations performed to the game machine GM1 by the player P. When the game machine GM1 obtains move information including the moving line ML and kick power (moving distance) determined by the competitor COP, the process of moving the competitor moving line CML is executed by setting the moving line ML indicated in the move information to the competitor moving line CML of the ball mass BM102, and setting the kick power indicated in the move information to the moving distance of the competitor moving line CML. The moving line ML of the ball mass BM101 corresponding to the competitor moving line CML is pushed out by the competitor moving line CML to move in the left direction with the competitor moving line CML.

When the game machine GM1 obtains the move information, the state that the character C102 kicks the soccer ball SB, and the kicked soccer ball SB hits the ball B100 existing on the character C102's side of the competitor moving line CML, and thereby the competitor moving line CML moves, is displayed in the game image GI100. The process executed after the balls B100 move is similar to the process in the player P's operation turn.

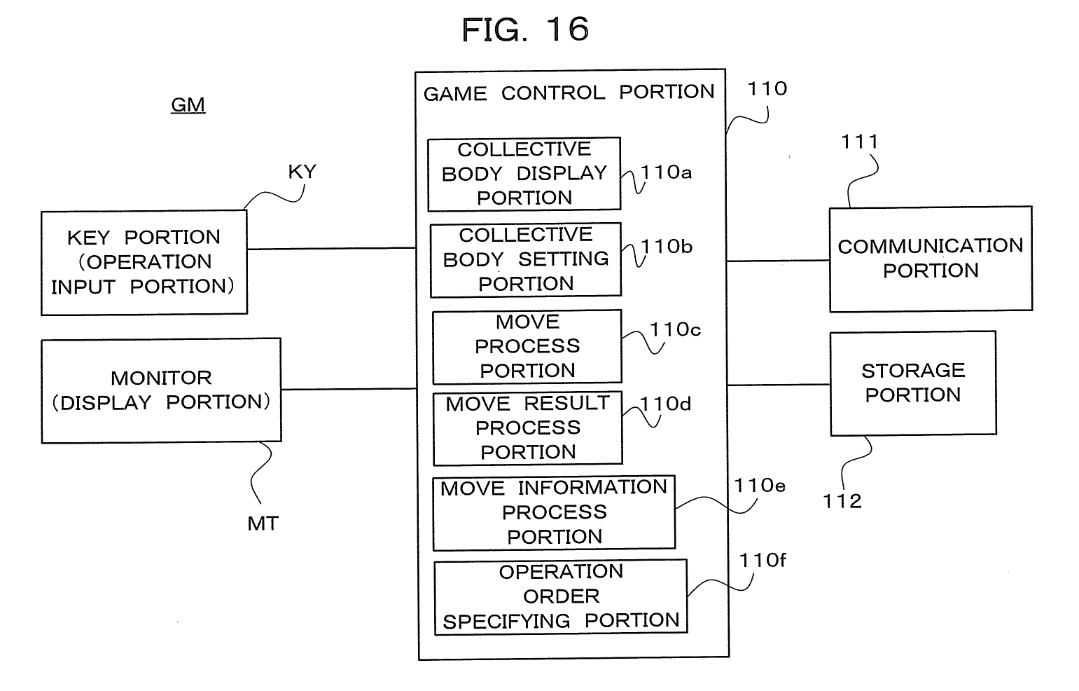

The configuration to realize the aforementioned game in the game machine GM will be described. First, a schematic hardware configuration in the game machine GM will be described using FIG. 16. The game machine GM comprises, besides a key portion KY as an operation input portion and a monitor MT as a display portion, a communication portion 111 for communicating data with another game machine GM, and a storage portion 112 where a game program for realizing the present invention and various data are stored, and a game control portion 110 to execute various kinds of control to execute the aforementioned game. The game control portion 110 comprises a CPU and various memory areas and timers necessary for the CPU's operation, and functions as a computer. By running the game program stored in the storage portion 112, the game control portion 110 functions mainly as a collective body display portion 110a, a collective body setting portion 110b, a move process portion 110c, a move result process portion 110d, a move information process portion 110e, and an operation order specifying portion 110f. The function of each of the portions 110a-110f will be described.

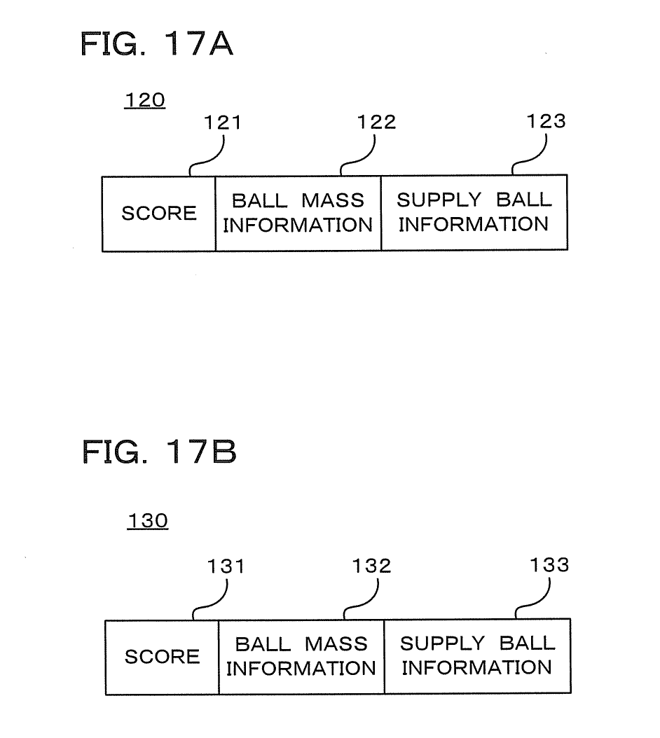

The data stored in the storage portion 112 will be described. In the storage portion 112, player information 120 and competitor information 130 are stored. The player information 120 is information of the player P which includes a score 121 of the player P, ball mass information 122 indicating a state of the ball mass 101 of the player P, and supply ball information 123 as to balls B100 to be supplied to the ball mass 101, as shown in FIG. 17A. The score 121 is displayed in the game image GI100 as the score SC101. The ball mass information 122 is information indicating the kind and position of each of the plural balls B100 constituting the current ball mass B101. The ball mass information 122 is linked to the display of the balls B100 in the ball mass BM101. When the information of each ball B100 in the ball mass information 122 changes by the game control portion 10, in accordance with the change, the display of the balls B100 in the ball mass BM101 changes.

The supply ball information 123 is information where, with respect to each of the first column to the fifth column of the ball mass BM101, an order (hereinafter, referred to as “the supplying order”) of the kind of ball 3100 to be supplied to each column is set. For example, the ball mass BM101 is formed at the moment of game start, by supplying, at the moment of game start, the first ball 3100 to the sixth ball B100 for each column. After that, for each column, by following the supplying order set in the supply ball information 123, the predetermined kind of ball B100 is supplied to the ball mass BM101. Additionally, it is enough that information 121 to 123 included in the player information 120 is linked to each other by, for example, an identification information of the player P, it is not needed that the information 121 to 123 is formed into one record physically.

The competitor information 130 is information of the competitor COP which includes a score 131 of the competitor COP, ball mass information 132 indicating a state of the competitor COP's ball mass BM102, and supply ball information 133 of the balls B100 to be supplied to the ball mass BM102, as shown in FIG. 17B. The score 131 is displayed in the game image GI100 as the score SC102. The ball mass information 132 is information indicating the kind and position of each of the plural balls B100 constituting the current ball mass BM102. The ball mass information 132 and the display of the balls B100 in the ball mass BM102 are linked to each other. When the information of each ball B100 in the ball mass information 132 changes by the game control unit 110, in accordance with the change, the display of the balls B100 in the ball mass BM102 also changes.

The supply ball information 133 is information where, with respect to each of the first column to the fifth column of the ball mass BM102, an order (hereinafter, referred to as “the supplying order”) of the kind of ball B100 to be supplied to each column is set. For example, the ball mass BM102 is formed at the moment of game start, by supplying, at the moment of game start, the first ball B100 to the sixth ball B100 for each column. After that, for each column, by following the supplying order set in the supply ball information 133, the predetermined kind of ball B100 is supplied to the ball mass BM102.

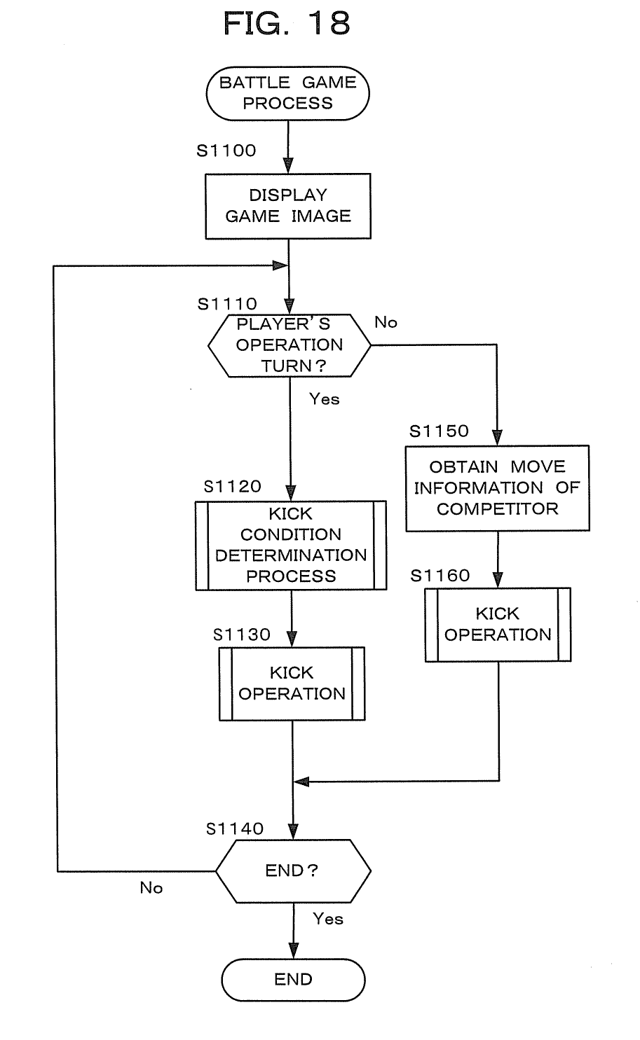

Next, a battle game process to be executed to execute the game between the game machine GM1 and the game machine GM2 will be described by following a flow chart shown in FIG. 18. The battle game process is controlled by the game control unit 110. When the game starts, firstly at step S1100, the ball mass BM 100 of the player P is set to the ball mass BM101, and the ball mass BM 100 of the competitor COP is set to the ball mass BM102. As mentioned above, the game image GI100 indicating the ball mass BM101 and the ball mass BM102 adjacent to each other with respect to the line direction LD, is displayed in the monitor MT. Thereby, the game control unit 110 functions as the collective body display portion 110a and the collective body setting portion 110b. The kinds of the balls B100 constituting each ball mass BM100 is determined based on the ball mass information 122, 132.

Next, at step S1110, it is determined whether the current turn is the player P's operation turn or not. Thereby, the game control portion 110 functions as the operation order specifying portion 110f. As the game of the present invention is a turn-based game, the player P's operation and the competitor COP's operation are set alternately. At step S110, when it is determined that the current turn is the player P's operation turn, the process goes to step S1120. At step S1120, a kick condition determination process is executed. In the kick condition determination process, based on the operation by the player P, the moving line ML and the kick power as the moving distance are determined. The detail of kick condition determination process will be described later.

When the kick condition is determined, the process goes to step S1130 to execute a kick process. In the kick process, based on the determined kick condition, that is, the determined moving line ML and kick power, the moving line ML of the ball mass BM 101 is moved, and the scores are calculated based on the state of the post-moved ball masses BM101, BM102. The detail of kick process will be described later. After the kick process, the process goes to step S1140 to determined whether the game should end or not. For example, when a predetermined time period has elapsed after the game starting, it is determined that the game should end. Alternatively, the game may be configured so that it is determined that the game should end when the ball mass BM101 of the player P or the ball mass BM102 of the competitor COP becomes a predetermined state. In a case that it is determined that the game should end, the game is terminated, and in a case that it is not determined that the game should end, the process returns to step S110.

On the other hand, at step S1110, when it is determined that the current turn is not the player P's operation turn, which means that the current turn is the competitor COP's operation turn, the process goes to step S1150. At step S1150, the move information of the competitor COP is obtained from the game machine GM2. In the move information, the moving line ML and kick power of the competitor are set, the moving line ML and kick power being determined based on the operation by the competitor COP. When the move information is obtained, the process goes to step S1160 to execute the kick process based on the moving line ML and kick power set in the move information. In the kick process at step S1160, the process similar to the aforementioned kick process of step S1130 is executed by setting the moving line ML in the kick process of step S1130 to the competitor moving line CML. The detail of the kick process for the competitor COP will be described later. After the kick process ending, the process goes to step S1140.

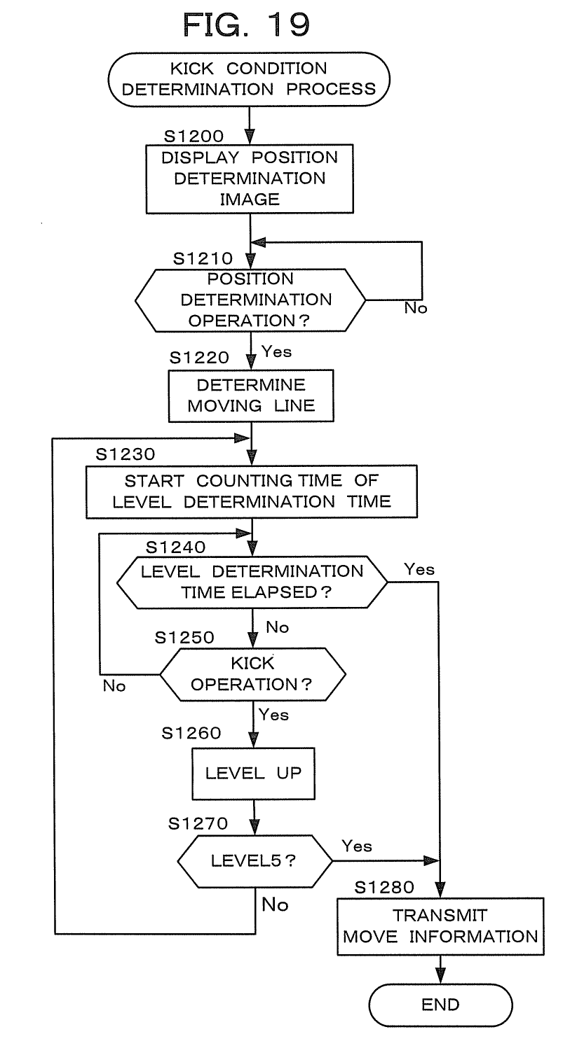

The kick condition determination process will be described by following a flow chart shown in FIG. 19. Firstly, at step S1200, the position specifying symbol PS is displayed in the game image GI100. The position specifying symbol PS, as mentioned above, moves in the column direction RD as indicating each line of the ball mass BM101. Subsequently, the process goes to step S1210, the process moves into a state of waiting the position determination operation. When the position determination operation is performed by the player P, the process goes to step S1220. At step S1220, the position specifying symbol PS is stopped at the timing replying to the position determination operation, and the line indicated by the position specifying symbol PS which has been stopped is determined as the moving line ML.

Subsequently, the process goes to step S1230, the count of level determination time is started, and at successive step S1240, it is determined whether the level determination time has elapsed or not. The level determination time of the present invention is, for example, 0.5 seconds. In a case that it is determined the level determination time has elapsed, the process goes to step S1280. On the other hand, within the level determination time, it is determined whether a kick operation has been performed or not by the player P at step S1250. For example, a state that a predetermined kick operation key in the key portion KY has been pressed down is regarded as the kick operation. In a case that it is determined there is no kick operation, the process returns to step S1240. In a case that it is determined there is a kick operation, the process goes to step S1260 to increase the level of kick power by one level. In accordance with the change of level, the display of level gauge LG101 is also changed.

Subsequently, at step S1270, it is determined whether the kick power reaches the level 5 or not. In a case that the kick power reaches the level 5, the process goes to step S1280. In a case that the kick power does not reach the level 5, the process returns to step S1230. In this way, depending on the number of times the kick operation is performed, it is possible to set the kick power up to the level 5. However it is necessary that a successive kick operation after a kick operation being performed is performed within the level determination time. At step S1280, the move information is generated, the move information including the determined kick condition, that is, the determined moving line ML and the determined kick power, and the generated move information is transmitted to the game machine GM2. Thereby, the game control portion 10 functions as the move information process portion 110e. When the move information is transmitted, the kick condition determination process is terminated.

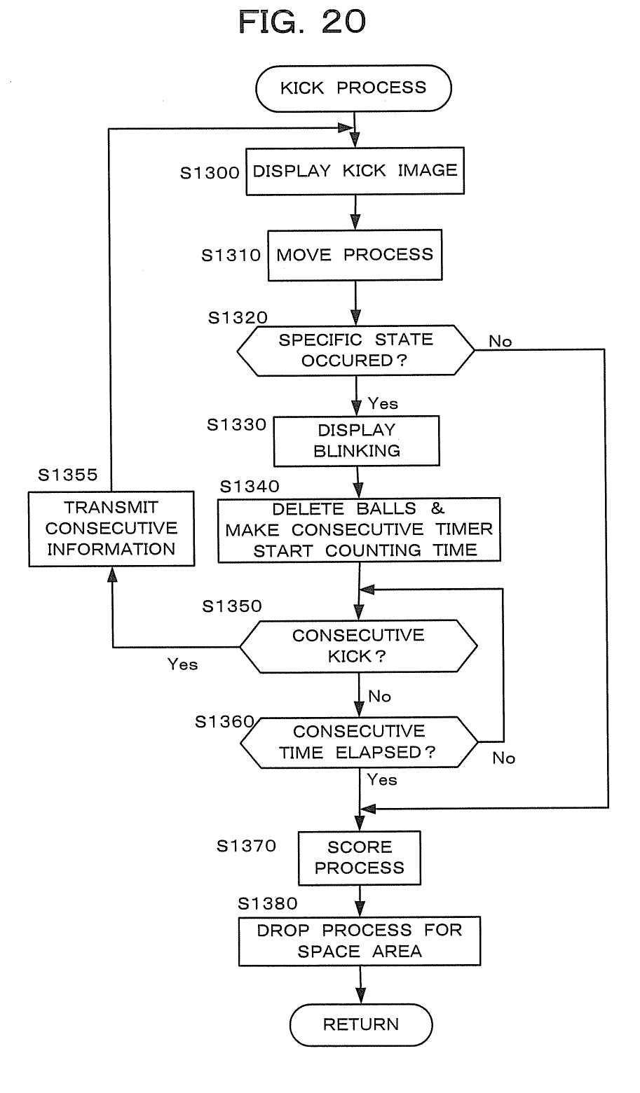

The kick process will be described by following a flow chart shown in FIG. 20. When the game control portion 110 changes information set in the ball mass information 122, 132, based on the change, the display of the balls constituting the ball mass BM100 in the kick process to be described changes. The kick process is executed in both of the player P's operation turn and the competitor COP's operation turn. Firstly, the kick process to be executed in the player P's operation turn will be described.

At step S1300, a kick image is displayed in the monitor MT. In the kick image, a state that the character C101 kicks the soccer ball SB, and the kicked soccer ball SB hits the character C101's side of the moving line ML is displayed. After displaying the kick image, the process goes to step S1310 to execute a move process. Thereby, the game control unit 110 functions as the move process portion 110c. In the move process, the balls B100 constituting the moving line ML are moved to the competitor's direction depending on the level of the kick power.

With the move of the moving line ML, the competitor moving line CML is also moved so as to be pushed out by the moving line ML. For example, in a case that the kick power is level 1, the moving line ML and the competitor moving line CML move for one-ball distance. Thereby, a space area corresponding to one ball B100 occurs at the character C101's side of the moving line ML, and one ball B100 positioning at the character C102's side of the competitor moving line CML is pushed out and deleted.

Next, the process goes to step S1320, it is determined whether the specific state SS has occurred or not in the ball masses BM101,BM102 after the moving line ML and the competitor moving line CML moving. When the specific state SS has not occurred, the process goes to step S1370. When the specific state SS has occurred, the process goes to step S1330 to make the balls B100 constituting the specific state SS blink. Subsequently, at step S1340, while the balls B100 being made to blink are deleted, the time counting by a consecutive timer is started. The consecutive timer is a timer which counts consecutive time in which a consecutive kick is permitted. Next, at step S1350, it is determined whether the consecutive kick has been performed or not. It is determined that the consecutive kick has been performed in a case that a predetermined consecutive kick operation key in the key portion KY has been pressed down by the player P.

When it is determined that the consecutive kick has been performed at step S1350, consecutive information indicating that the consecutive operation has been performed is transmitted to the game machine GM2 at step S1355. After that, the process returns to step S1300 and the process for the consecutive kick is executed. With respect to the consecutive kick, the moving distance of the moving line ML as step S1310 may be, for example, the same as the moving distance of the last kick, or a predetermined moving distance as a moving distance of the consecutive kick. On the other hand, in a case that it is determined that the consecutive kick has not been performed at step S1350, the process goes to step S1360 to determine whether the consecutive time has elapsed or not.

When it is determined that the consecutive time does not elapse at step S1360, the process returns to step S1350 and moves into a state of waiting the consecutive kick. When it is determined that the consecutive time has elapsed, the process goes to step S1370. At step S1370, a score process is executed. In the score process, based on the occurrence of the specific state SS, points of the player P and the competitor COP are calculated, the scores 121,131 are updated, and in accordance with this update, the display of the scores SC101, SC102 in the game image GI100 are updated respectively. In the score process, the game may be configured such that minus points are set in a case that no specific state SS has occurred.

After the score process, the process goes to step S1380. At step S1380, to the space areas caused by the specific state SS and the move of the moving line ML respectively, a drop process is executed so as to fill up the space area. In the drop process, the balls B100 existing above the space area in the column direction RD falls so as to fill up the space area. Caused by this drop process, space areas occurs at the top portion of the ball masses BM101,BM102 respectively. So as to fill up the space area which has occurred at the top portion of the ball mass BM100, new supply balls B100 are supplied. The order of kind of balls B100 to be supplied to each column in the ball mass BM101,BM102 is determined based on the supply ball information 123,133 as mentioned above. When the drop process for the space areas is completed, the kick process is terminated. BY step S1320 to step S1370 in the kick process, the game control portion 110 functions as the move result process portion 110d, and by step S1380, the game control portion 110 functions as the collective body display portion 110a.

In the game machine GM1 of the player P, a kick process to be executed in the competitor COP's operation turn will be described. In the kick process in this case, the move information transmitted from the game machine GM2 is waited, the moving line ML set in the obtained move information is treated as the competitor moving line CML, and the kick power set in the move information is treated as the kick power which for moving the competitor moving line CML. The move of the competitor moving line CML in the competitor COP's operation turn and the move of the moving line ML in the player P's operation turn are displayed symmetrically with respect to the central portion of the game image.

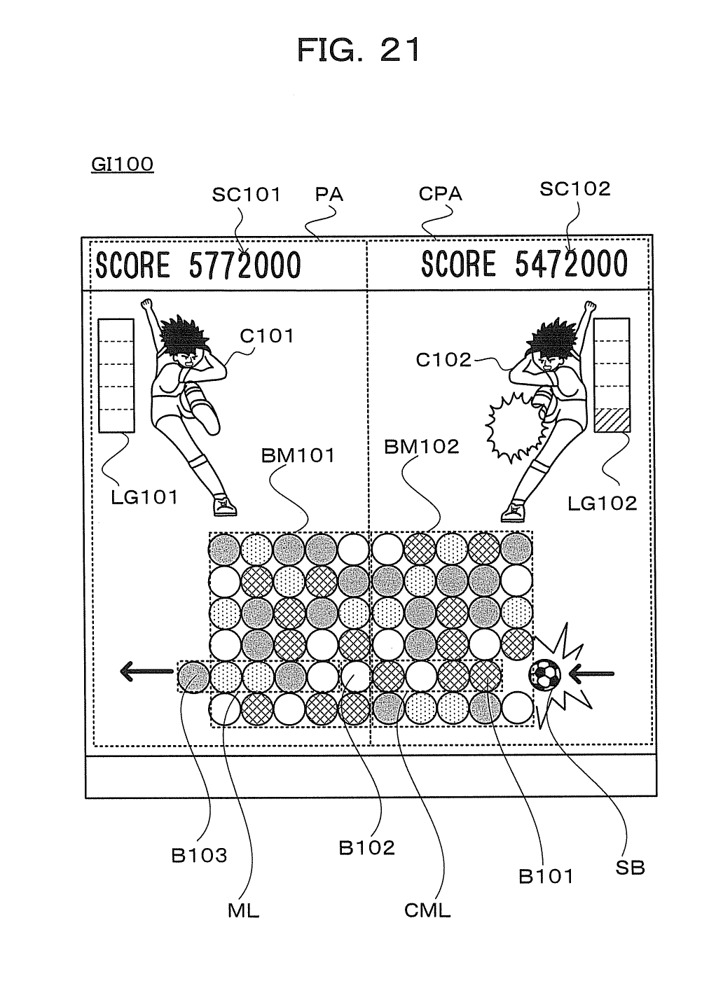

Firstly, at step S1300, as the kick image, a state that the character C102 kicks the soccer ball SB, and the kicked soccer ball SB hits the competitor moving line CML from the character C102's side, is displayed as shown in FIG. 21. Subsequently, at step S1310, depending on the kick power of the competitor COP, the competitor moving line CML is moved in a direction to the player area PA (hereinafter, this direction is referred to as “the player direction”). Caused by the move of the competitor moving line CML, the moving line ML of the ball mass BM101 corresponding to the competitor moving line CML is moved so as to be pushed out by the competitor moving line CML. Hereinafter, the processes of step S1320 to step S1380 are similar to the processes above mentioned. However, when it is determined whether the consecutive kick has been performed at step S1350, in a case that the consecutive information is obtained from the game machine GM2, it is determined that the consecutive kick has been performed, and the transmission of the consecutive information in step S1355 is not necessary.

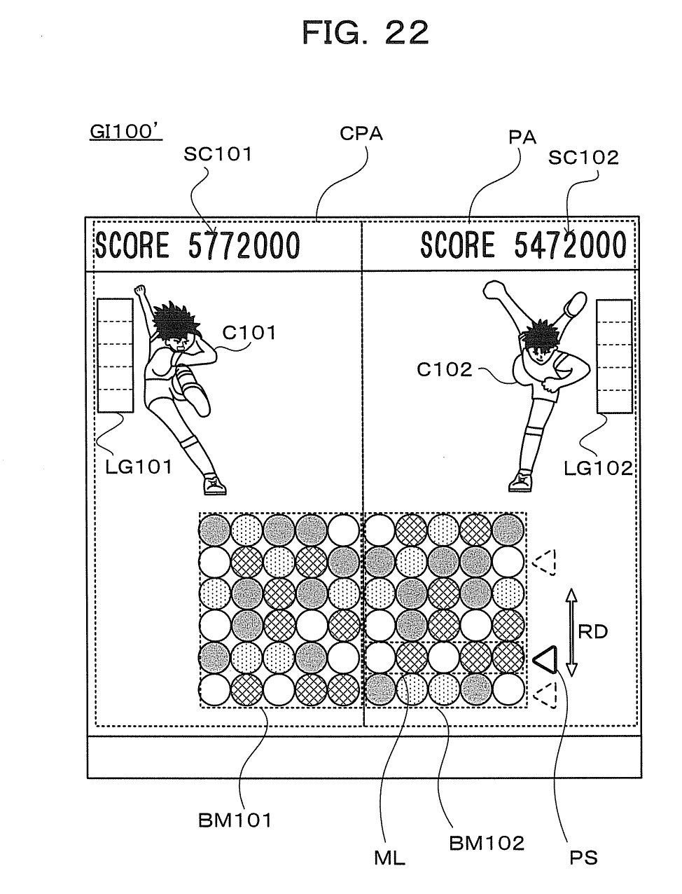

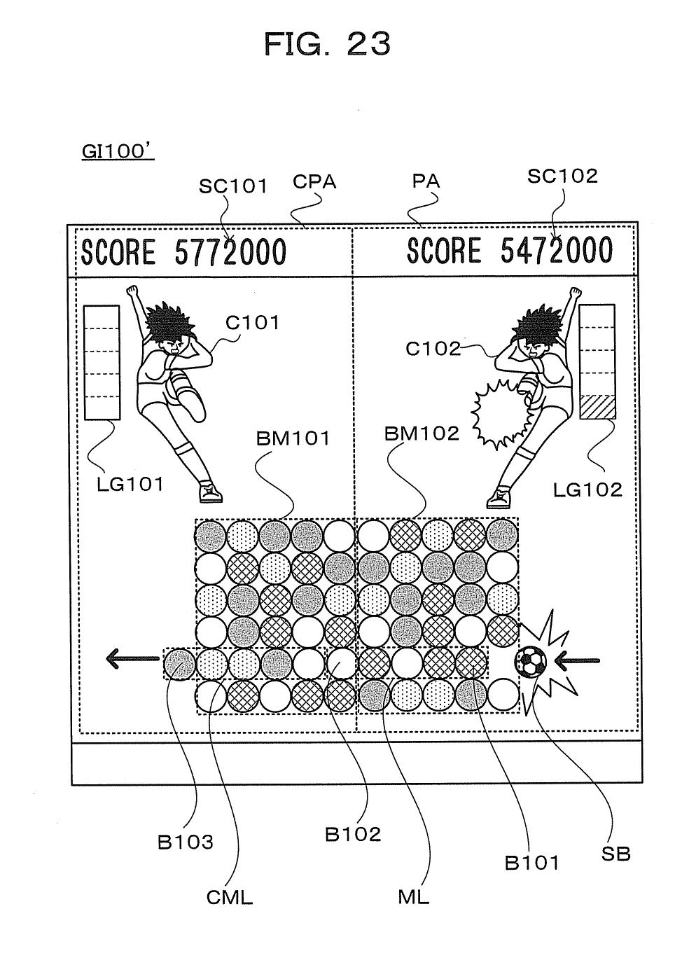

Next, the process executed in the game machine GM2 of the competitor COP will be described. In the game machine GM2, the mentioned battle game is executed treating the competitor COP as the player P and treating the player P operating the game machine GM1 as the competitor COP. The game image GI100′ which is displayed in the monitor MT of the game machine GM2 is similar to the game image GI100 which is displayed in the monitor MT of the game machine GM1. However, as the competitor COP operating the game machine GM2 is treated as the player P (hereinafter, referred to as “the player P′”), the player P operating the game machine GM1 is treated as the competitor COP (hereinafter, referred to as “the competitor COP”), as shown in FIGS. 22 and 23, a right half of the game image GI100′ is the player area PA, where some information associated with the player P′ such as the character C102, the ball mass BM102, the score SC102, and the level gauge LG102 are displayed.

On the other hand, a left half of the game image GI100′ is the competitor area CPA, and in the competitor area CPA, some information associated with the competitor COP′ such as the character C101, the ball mass BM101, the score SC101, and the level gauge LG101 are displayed. It is enough that the processes with respect to the character C102, the ball mass BM102, the score SC102, and the level gauge LG102 in the battle game process in the game machine GM2 are executed as the processes with respect to the character C101, the ball mass BM101, the score SC101, and the level gauge LG101 in the battle game process in the game machine GM1. Also, it is enough that the processes with respect to the character C101, the ball mass BM101, the score SC101 and the level gauge LG101 in the battle game process in the game machine GM2 are executed as the processes with respect to the character C102, the ball mass BM102, the score SC102 and the level gauge LG102 in the battle game process in the game machine GM1.

In the game image GI100′, as shown in FIG. 22, the position specifying symbol PS which is displayed at the character C102's side of the ball mass BM102a is displayed at the position symmetrical to the position specifying symbol PS which is displayed in the game machine GM1. Moreover, the moving direction of the moving line ML and the competitor moving line CML which are moved by the operation performed by the player P′ is also symmetrical to the moving direction of the moving line ML and the moving direction of the competitor moving line CML in the game machine GM1 with respect to the center portion of the game image GI100′, as shown in FIG. 23.

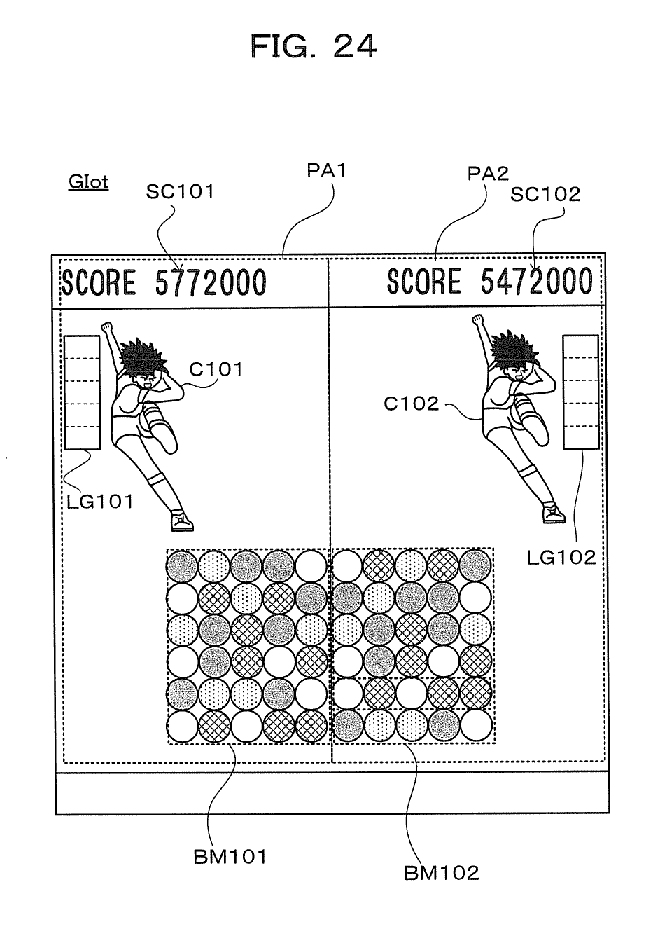

The present invention is not limited to above mentioned embodiment and can be executed in various modes as the first embodiment. For example, one game machine GM can be configured so as to be operated by two players P1, P2 which battles with each other. The game image GIot to be displayed in the monitor MT comprises, as shown in FIG. 24, a player area PA1 and a player area PA2 corresponding to the players respectively. In the player area PA1, the score SC101, the character C101, the ball mass BM101, and the level gauge LG101 are displayed as with the mentioned player area PA in the game image GI100 which is displayed in the monitor MT of the game machine GM1. In the player area PA2, the score SC102, the character C102, the ball mass BM102, and the level gauge LG102 are displayed, which correspond to the score SC102, the character C102, the ball mass BM102, and the level gauge LG102 respectively in the mentioned player area PA of the game image GI100 which is displayed in the monitor MT of the game machine GM2.

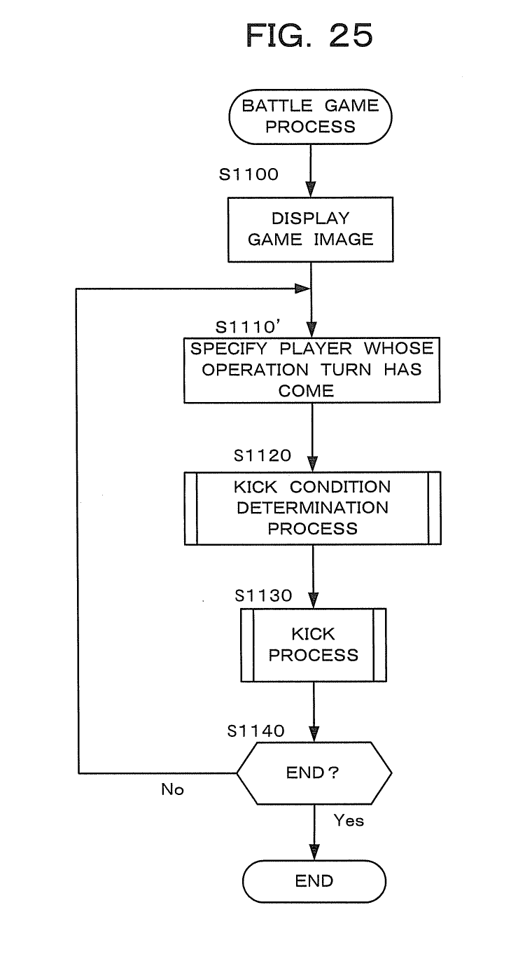

In a case that the battle game is executed by one game machine GM, the processes to be executed in “the battle game process” will be described by following a flow chart shown in FIG. 25. At step S1100 where the game image is displayed, the game image GIot above mentioned is displayed in the monitor MT. At successive step S1110′, a player whose turn has come is specified out of the players P1, P2. With respect to the player whose turn has come, the kick condition determination process at step S1120 and the kick process at step S1130 are executed.

The processes with respect to the player P1 can be similar to the kick condition determination process and the kick process with respect to the player P of the game machine GM1. The processes with respect to the player P2 can be similar to the kick condition determination process and the kick process with respect to the player P′ of the game machine GM2. However, the transmission of move information (step S1280) in the kick condition determination process and the transmission of consecutive information (step S1355) in the kick process, are not necessary.

3. The Second Embodiment of the Second Game Machine

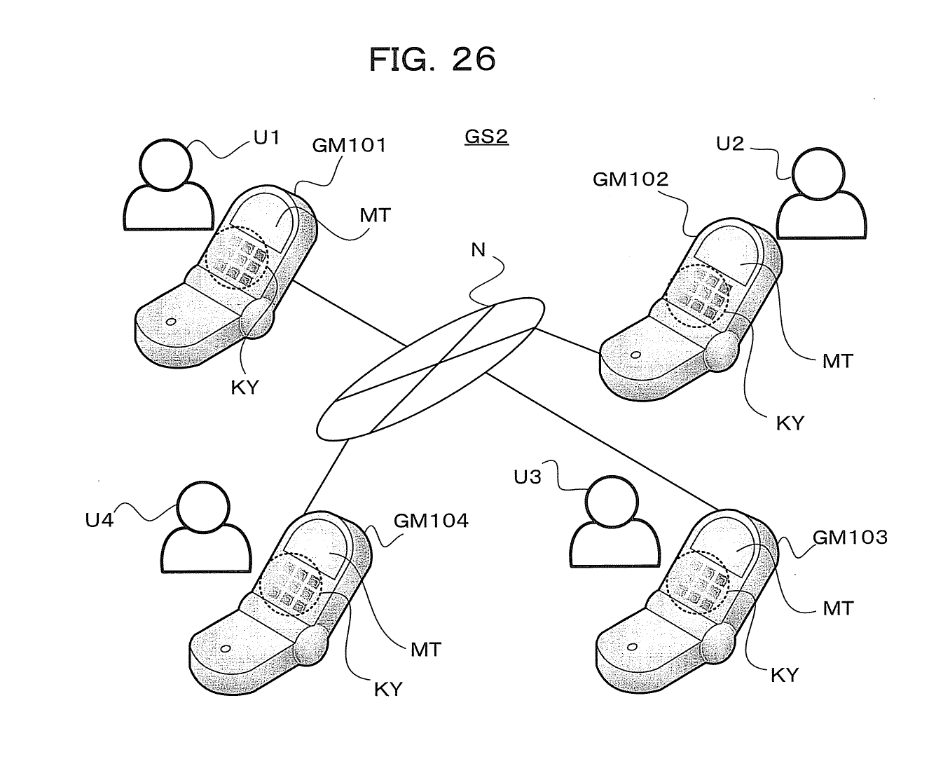

In the first embodiment, one example of an embodiment where two people battle with each other was described. In the second embodiment, an embodiment where four people battle with each other will be described. Hereinafter, mainly, the points different from the first embodiment will be described. To an object or a step given the same reference number as the first embodiment, a corresponding object or step in the first embodiment can be applied. FIG. 26 shows one example of game system GS2 as the second embodiment, the game system GS2 comprising the game machines GM101 to GM104 of the present invention. The four of game machines GM101 to GM104 are operated by the four of users U1 to U4 respectively. Each of the game machines GM101 to GM104 is a portable-type phone having the monitor MT and the key portion KY, and is configured so that they can communicate data with each other via a network N. Hereinafter, when it is not necessary to distinguish each of the game machines GM101 to GM104, they are referred to as “the game machine GM100”, and when it is not necessary to distinguish each of the users U1 to U4, they are referred to as “the user U”.

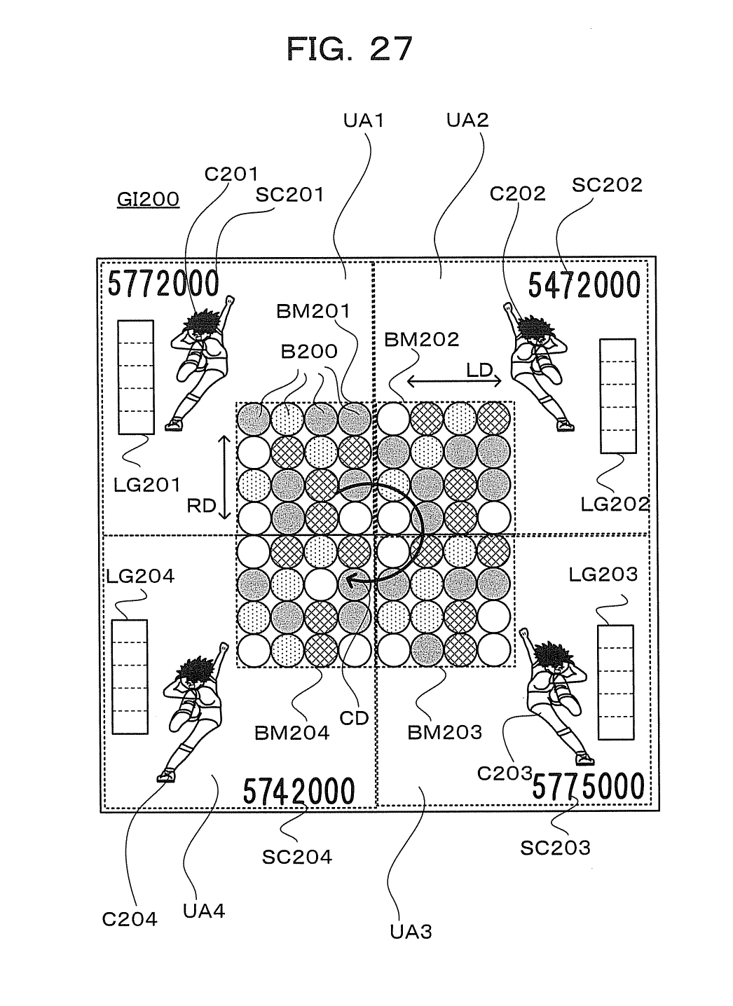

The game executed in the game machine GM100 is a so-called falling objects game which is similar to the game executed at the game machine GM in the first embodiment. A basic configuration of a game image G1200 to be displayed in the present game will be described using FIG. 27. The game image G1200 comprises four of user areas UA1 to UA4. The four of user areas UA1 to UA4 correspond to the users U1 to U4 respectively. In each of the user areas UA1 to UA4, the information with respect to the corresponding users U1 to U4 respectively. For example, in the user area UA1 corresponding to the user U1, as the information with respect to the user U1, a ball mass BM201, a character C201, a score SC201, and a level gauge LG201 are displayed.

Hereinafter, when it is not necessary to distinguish each of the user areas UA1 to UA4, they are referred to as “the user area UA”. When it is not necessary to distinguish each of the ball masses BM201 to BM204, they are referred to as “the ball mass BM200”. When it is not necessary to distinguish each of the characters C201 to C204, they are referred to as “the character C200”. When it is not necessary to distinguish each of the scores SC201 to SC204, they are referred to as “the score SC200”. When it is not necessary to distinguish each of the level gauges LG201 to LG204, they are referred to as “the level gauge LG200”.

The ball masses BM201 to BM204 are arranged successionally in the circumferential direction CD of the game image G1200 so as to be adjacent in the line direction LD or the column direction RD. Each ball mass BM200 is constituted by a plurality of kinds of balls B200 as a plurality of kinds of component objects. The plural balls B200 in each ball mass BM200 are arranged in the shape of a matrix having 4 balls in the line direction LD and 4 balls in the column direction RD. Each of the balls B200, which have same shape and same size, can be distinguished to each other in a pattern and color thereof. The game image G1200 which is displayed in each of the game machines GM101 to GM104 can be configured so that the same image is displayed in all of the game machines GM100, or the user area UA of the user U operating the game machine GM is located at the top-left portion in the game image G1200. The present embodiment will be described in a case that the same game image G1200 is displayed in each game machine GM.

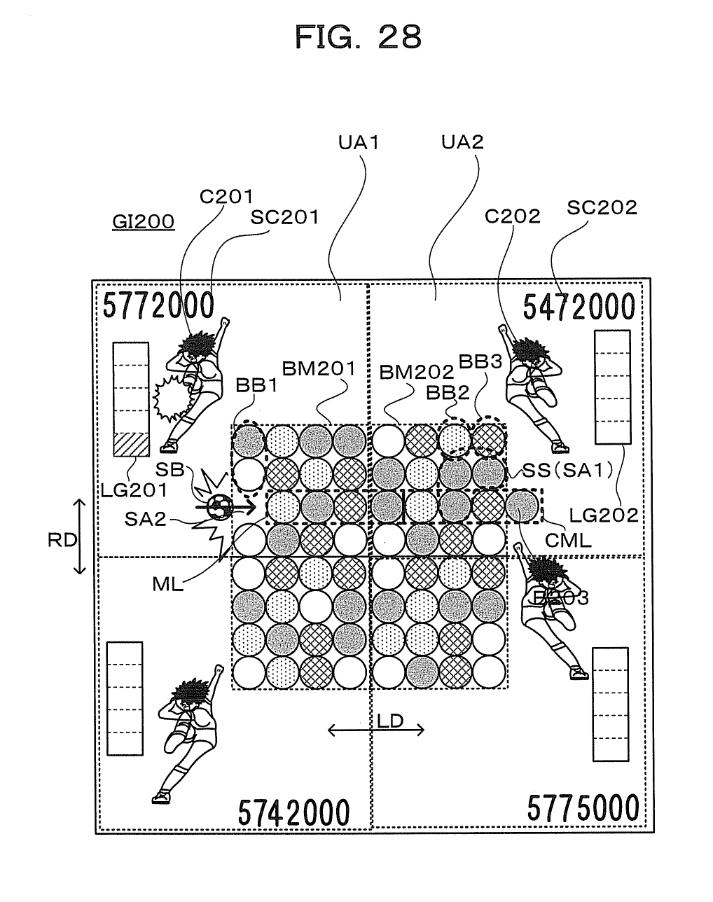

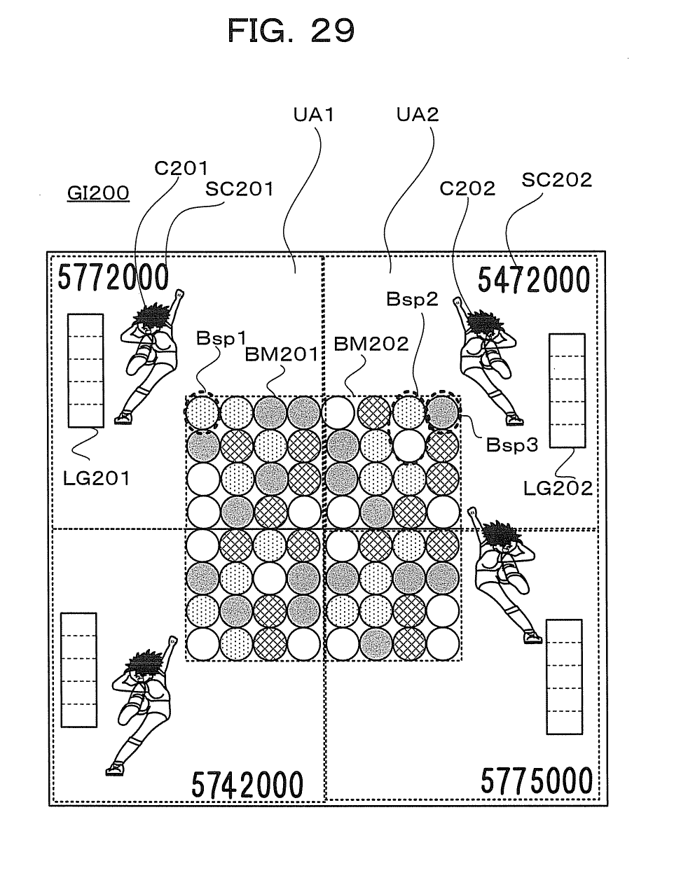

As with the game in the first embodiment, the present game is a battle game, where the character C200 is made to kick the soccer ball SB, by the kicked soccer ball SB the ball mass BM200 is broken, and players compete for higher score SC200. The present game is a turn-based game, the operation turn of each of the users U1 to U4 is specified sequentially. The game image G1200 will be described in a case that, for example, the user U1 is specified as the user of the current operation turn (hereinafter, referred to as “the operation user”, using FIGS. 28 and 29. In a case that the operation user is the user U1, the user U1 corresponds to the player P in the first embodiment, and the user area UA1 correspond to the player PA in the first embodiment. In the user area UA1, the position specifying symbol PS is displayed as with the first embodiment, and the moving line ML and the kick power are determined in reply to the operation by the user U1.

The ball mass BM200 adjacent to the ball mass BM201 of the user U1 in the circumferential direction CD and the user area UA2 correspond to the ball mass BM100 and the competitor area CPA of the competitor COP in the first embodiment respectively. Hereinafter, the user U who corresponds to the ball mass BM200 adjacent to the ball mass BM200 of the operation user in the circumferential direction CD, is referred to as “the adjacent competitor”, and the competitor different from the adjacent competitor is sometimes referred to as “the other competitor”. The relation between the operation user and the adjacent competitor in the second embodiment corresponds to the relation between the player P and the competitor COP in the first embodiment.

Based on the moving line ML and the kick power determined by the operation of the operation user, the moving line ML in the ball mass BM201 of the operation user U1 moves in the line direction LD depending on the kick power. Then, the competitor moving line CML which is pushed by the moving moving line ML also moves so as to be pushed out by the moving line ML. FIG. 28 corresponds to the kick image in the first embodiment, and shows a state that the moving line ML and the competitor moving line CML move in the line direction LD by the kick power of one-ball distance. The ball B203 arranged at the moving direction side of the competitor moving line CML is pushed out of the ball mass BM202 and after that deleted. After the moving line ML and the competitor moving line CML move, the processes similar to the processes in the first embodiment are executed appropriately for the state of the post-moved ball mass BM201 of the operation user U1 and the post-moved ball mass BM202 of the adjacent user U2, the situation after the movement of the lines ML,CML. Lastly, the scores SC201, 202 of the operation user U1 and the adjacent competitor U2 are calculated respectively.

Concretely, when by the movement in the line direction LD of the moving line ML and the competitor moving line CML, the specific state SS occurs, the three balls B200 constituting the specific state SS are deleted. Thereby, the area where the specific state SS has occurred changes into a space area SA1. Additionally, a space area SA2 also occurs at the side where the soccer ball SB has hit the moving line ML. For the space areas SA1, SA2 which has occurred, the ball groups BB1 to BB3 arranged in the column direction RD of the space areas SAL SA2 falls in the column direction RD so as to fill up each of the space areas SA1, SA2.

Caused by the falling, as space areas occurs at the top portion of each of the ball masses BM201,BM202, supply ball groups Bsp1 to Bsp3 are supplied so as to fill up the space areas. It does not matter how each of the supply ball groups Bsp1 to Bsp3 are supplied to the corresponding space area, but it is preferable that the supply balls are supplied by falling from the top portion of each of the user areas UA1,UA2 toward the space area. FIG. 29 shows a state that the supply ball groups Bsp1 to Bsp3 have been supplied to the space areas which has occurred at the top portion of the ball masses BM201,BM202. Thereby, it is possible to keep the shape of ball mass BM200 where the balls B are arranged in the shape of a 4 balls×4 balls matrix.

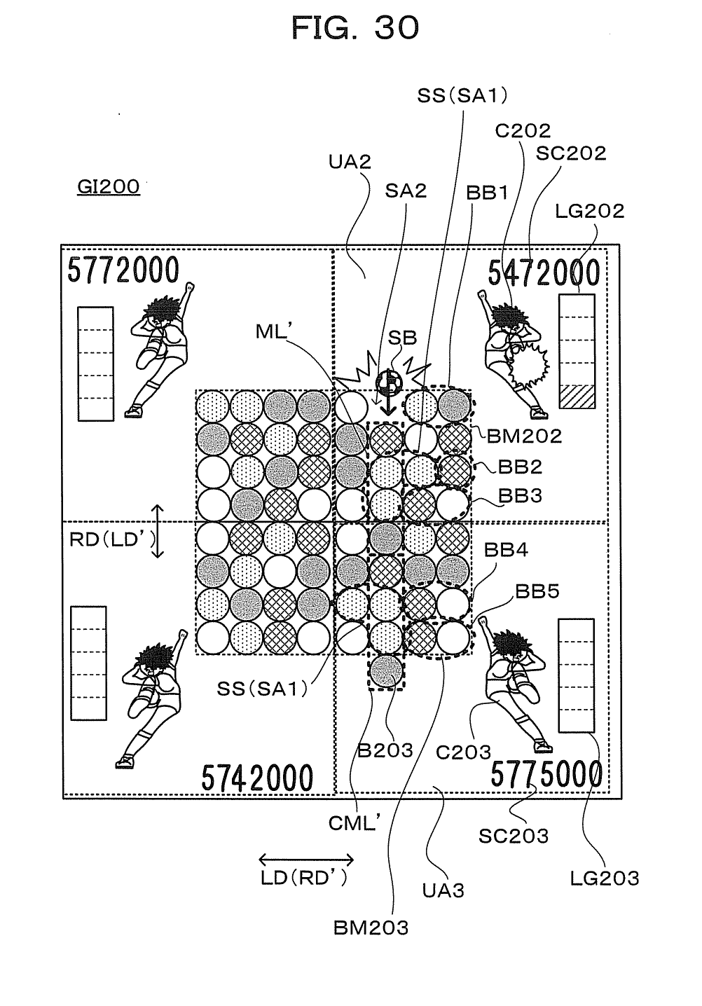

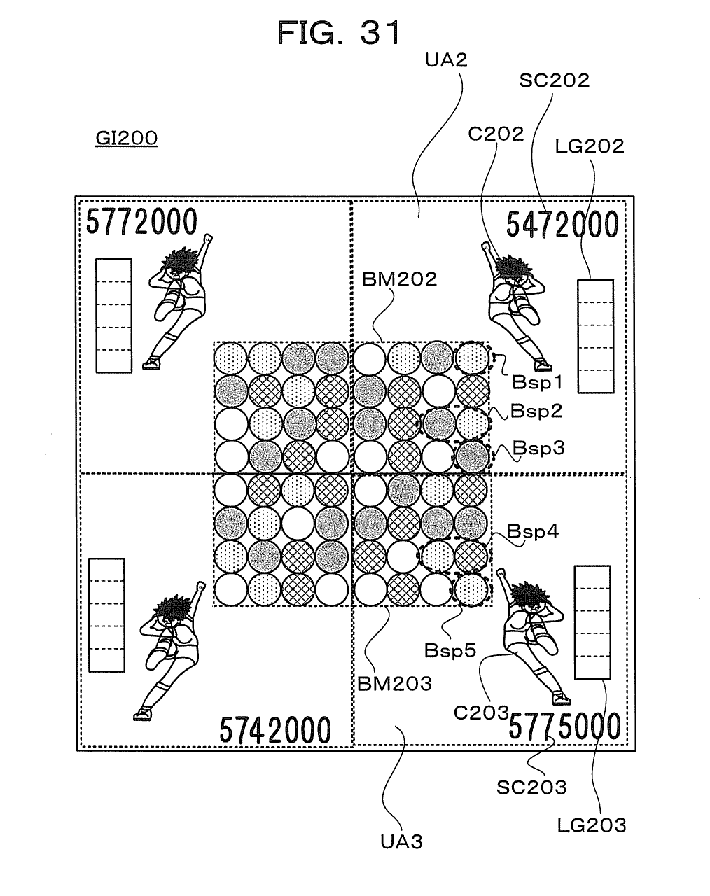

Next, a case that the user U2 is specified as the operation user will be described using FIG. 30 and FIG. 31. In this case, the user U3 is specified as the adjacent competitor. In this case, the ball mass BM202 of the operation user U2 is adjacent to the ball mass BM203 of the adjacent competitor U3 in the column direction RD. In the processes for the ball masses BM200 which are adjacent in the column direction RD to each other, it is enough that the column direction RD and the line direction LD are treated respectively as the line direction LD and the column direction RD in the processes in the case that two ball masses BM200 are adjacent to each other in the line direction LD. Namely, it is enough to execute processes similar to the processes in the case that two ball masses BM are adjacent to each other in the line direction LD, by treating the column direction RD and the line direction LD as a deemed line direction LD′ and a deemed column direction RD′ respectively, and treating the right-left direction as the up-down direction.

The processes with respect to the ball masses BM202,BM203 adjacent to each other in the column direction RD will be concretely described. Firstly, the position specifying symbol PS is displayed at the character C202's side, the character C202 being associated with the operation user U2, and by the operation of the operation user U2, the moving line ML′ and the kick power are determined. When the moving line ML′ is determined, the moving line ML′ and the competitor moving line CML′ to be pushed out by the moving line ML′ moves in the line direction LD′ depending on the kick power. FIG. 30 corresponding to the kick image in the first embodiment, shows a state that the moving line ML′ and the competitor moving line CML have moved in the deemed line direction LD′ depending on the kick power of one-ball distance. By the move of the competitor moving line CML′, the ball B203 located at the moving direction side of the competitor moving line CML′ is pushed out of the ball mass BM203, and after that deleted.

Caused by this move, in a case that the specific state SS occurs, the balls B200 constituting the specific state SS are deleted, and thereby, the space area SA1 occurs. So as to fill up the space area SA1 which has occurred base on the specific state SS and the space area SA2 which has occurred base on the move of the move lien ML, the ball groups BB1 to BB5 located in the column direction RD′ with respect to the space areas SA1, SA2 move in the column direction RD′. Thereby, space areas has occurred at the top portion of each of the ball masses BM202, BM203, that is, at the right side, and so as to fill up the space areas which have occurred, the supply ball groups Bsp1 to Bsp5 are supplied. It does not matter how each of the supply ball groups Bsp1 to Bsp5 is supplied to the corresponding space area, but it is preferable that the supply ball groups Bsp1 to BSp5 are supplied by moving toward the corresponding space area from the top portion, that is, the right side of the user areas UA2,UA3 each. FIG. 31 shows a state that the supply ball groups Bsp1 to Bsp5 have been supplied to the space areas which occurred at the top portion (the right side) of the ball masses BM202, BM203 each. Thereby, it is possible to keep the shape of the ball mass BM200 where the balls B200 are arranged in a 4 balls×4 balls matrix.

In a case that the user U3 is specified as the operation user, the user U4 is specified as the adjacent competitor, and in the game image G1200, the left-right symmetric image of the game image G1200 in a case that the user U1 is the operation user is displayed. Moreover, in a case that the user U4 is specified as the operation user, the user U1 is specified as the adjacent competitor. In the game image G1200 in this case, the up-down symmetric image of the game image G1200 in a case that the user U2 is the operation user.

Next, the processes which are executed in each game machine GM100 to realize the second game system GS2 of the present invention, will be described. The hardware configuration of the game machine GM100 is similar to the hardware configuration of the game machine GM shown in FIG. 16. However, in the storage portion 112, player information 120 is stored as information of the user U operating the game machine itself, and the competitor information 130 corresponding to each of the users U is stored as information of each of the other users U. For example, player information 120 and the competitor information 130 each can be distinguished by the identification information of each user U. Moreover, in the ball mass information 122,132, the position where each of the ball masses BM200 is located is also set. For example, the position set as an area number which is given to areas uniquely.

Next, the battle game process to be executed in the game machine GM100 will be described by following a flow chart shown in FIG. 18. In the present embodiment, in the battle game process to be executed in the game machine GM101 operated by the user U1, the player P corresponds to the user U1, and the competitor COP corresponds to all of the other users U2 to U4. When the game starts, firstly, in step S1100, the ball masses BM201 to BM204 are set to the users U1 to U4 respectively, the game image G1200 is displayed, where the ball masses BM201 to BM204 are adjacent to each other in the column direction RD or the line direction LD. Thereby, the game control portion 110 functions as the collective body display portion 110a and the collective body setting portion 110b. The kind of each of the balls B200 constituting the ball mass BM200 is determined based on the ball mass information 122, 132 of each user U.

Next, in step S1110, it is determined whether the operation turn of the player P, that is, the user U operating the game machine itself, has come or not. When an affirmative determination is obtained, at step S1110, the process goes to step S1120. At step S1120, the kick condition determination process is executed. In the kick condition determination process, the moving line ML and the kick power as the moving distance are determined based on the operation by the player P, that is, the user U operating the game machine itself. The details of the kick condition determination process will be described later.

When the kick condition is determined, the process goes to step S1130 to execute the kick process. In the kick process, based on the determined kick condition, that is, the determined moving line ML and the kick power, the moving line ML (ML′) in the ball mass BM200 of the operation user U and the competitor moving line CML (CML′) in the ball mass BM200 of the competitor are moved. Then, the points are calculated based on the situation of each of the post-moved ball masses BM200. The details of the kick process will be described later. After the kick process completing, the process goes to step S1140 to determine if the game should end or not. For example, when a predetermined time has elapsed after the game starts, it is determined that the game should end. It is possible to configure the game so that it is determined that the game should end when the ball mass BM200 of any one of the users U comes into a predetermined state. When it is determined that the game should end, the game is terminated. When it is not determined that the game should end, the process goes to step S1110.

On the other hand, when a negative determination is obtained at step S1110, which means that the operation turn of the user U operating the other game machine GM100 has come, and the process goes to step S1150. In step S1150, the move information of the user U in the operation turn, that is, the operation user U is obtained from the game machine GM100 which is being operated by the operation user. In the move information, the moving line ML (ML′) and kick power determined based on the operation by the operation user are included. When the move information is obtained, the process goes to step S1160 to execute the kick process based on the moving line ML (ML) and kick power included in the move information. In the kick process of the step S1160, the processes similar to the kick process of step S1130 are executed. The details of the kick process will be described later. After the kick process completes, the process goes to step S1140.

The kick condition determination process in the second embodiment is similar to the process in the first embodiment. However, in a case that the ball mass BM200 of the adjacent competitor is adjacent in the column direction RD, at step S1200, the position specifying symbol PS is moved in the line direction LD (the deemed column direction RD') while indicating each line in the ball mass BM200 of the player P (the user U operating the game machine itself). Moreover, as step S1280, the move information is generated, and transmitted to the other 3 game machines GM100 except for the game machine GM100 itself, the move information including the moving line ML(ML') and kick power determined based on the operation by the player P, and the information to distinguish the player P.

The kick process in the second embodiment will be described. Firstly, the kick image is displayed at step S1300. At the moment of displaying the kick image, the operation user and the adjacent competitor for the operation user are specified. For example, in a case that the user D1 is the operation user, the user U2 corresponding to the user area UA2 is specified as the adjacent competitor, the user area UA2 being adjacent to the user area UA1 in the circumferential direction CD. After that, it is enough to execute the process similar to the kick process with respect to the player P in the first embodiment by regarding the operation user as the player P in the first embodiment and the adjacent competitor as the competitor COP in the first embodiment. In a case that the ball mass BM200 of the operation user and the ball mass BM200 of the adjacent competitor are adjacent to each other in the column direction RD, as mentioned above, it is enough to execute the processes by regarding the deemed column direction RD′ as the column direction RD in the first embodiment, the deemed line direction LD′ as the line direction LS in the first embodiment, and the deemed up-down direction as the left-right direction in the first embodiment.

The present invention, as the second embodiment, is not limited to the above embodiment and can be realized in various embodiments. For example, each game machine GM100 may be configured so that the user area UA of the user U operating the game machine itself is displayed at the top-left portion of the game image G1200. In this case, in each game machine GM100, the position of user area UA of each of the other users U is set so that the relative positional-relation from the position of the user area UA of the user U operating the game machine itself is common to the game machines GM100, and it is enough that the position of corresponding user area UA is set to the ball mass information 122,132 in the player information 120 for each user U and each competitor information 130. It is enough that the processes of the move information obtained from the other game machine are executed by treating the user corresponding to the move information as the operation user and specifying the ball mass BM200 to be an operation object.

Moreover, the game system may be configured so that the user U can change the position of his/her own area UA appropriately. In this case, it is enough to configure the game system, so that the user U can set his/her user area UA at his/her demanding position, while a relative positional-relation of the user areas UA maintaining. Additionally, the number of balls B200 in the column direction RD and the line direction LD of the ball mass BM200 is not limited to 4. The number of balls B200 arranged in the column direction RD may be different from the number of balls B200 arranged in the line direction LD. The direction in which the plural ball masses BM200 are arranged successionally is not limited to the circumferential direction, and it is enough that the plural ball masses BM200 are arranged successionally in a predetermined direction, so that they are adjacent in the column direction or the line direction.

1. A game machine comprising:
an operation input portion which accepts operations performed by a player;
a display portion which displays a game image; and
a game control portion which controls a game where a state of a collective body constituted by plural kinds of component objects is changed in reply to the operation by the player in the display portion; wherein
the game control portion has:
a collective body display portion which makes the display portion display the collective body constituted by plural columns and plural lines where the plural kinds of component objects are arranged in a column direction or in a line direction;
a moving line determination portion which determines a moving line to be moved out of the plural lines of the collective body;
a moving distance determination portion which determines a moving distance for which the moving line is moved in replay to a moving distance determination operation by the player;
a move execution portion which, when the moving distance is determined by the moving distance determination portion, to the collective body displayed by the display portion, moves the component objects arranged on the moving line in the line direction depending on the moving distance;
a state determination portion which, to the collective body post-moved by the move execution portion, determines whether or not the plural kinds of component objects constituting the collective body have established a predetermined state with respect to the kinds;
a component object deletion portion which, when it is determined that the predetermined state has been established, generates a deletion portion in the collective body post-moved by deleting the plural component objects establishing the predetermined state in the collective body; and
a post-deletion move portion which moves the component objects arranged on the column of each deleted component object in the column direction so as to fill up the deletion portion generated.

2. The game machine of claim 1, wherein
the moving distance determination portion determines the moving distance depending on a volume of the moving distance determination operation.

3. The game machine of claim 2, wherein
the moving distance determination portion increases, after the moving distance determination operation being performed, the moving distance each time when the moving distance determination operation is performed in a predetermined time, and when the moving distance determination operation is not performed in the predetermined time, determines the moving distance at the moment as the moving distance for which the determined moving line is moved.

4. The game machine of claim 1, wherein
the moving line determination portion indicates sequentially a specific line out of the plural lines displayed in the game image, and determines as a line to be moved, the specific line at the moment when the moving distance determination operation is performed by the player.

5. The game machine of claim 1, wherein
the move execution portion,
in a case that a consecutive move operation is performed by the player after the component object deletion portion deleting the component objects establishing the predetermined state until the post-deletion move portion moving the component objects located in the column direction of the deleted component objects,
further moves the component objects on the moving line for a predetermined moving distance in the line direction in the collective body where the plural component objects have been deleted.

6. The game machine of claim 1, wherein
the state determination portion, after the component objects being moved by the post-deletion move portion, further determines whether or not the plural kinds of component objects in the post-moved collective body establish the predetermined state.

7. The game machine of claim 1, wherein
the move execution portion, so as to fill up a space area where the component objects have gone in the moving line by the move in the line direction, moves in the column direction, the component object arranged on each column of the space area, and
the state determination portion determines whether the predetermined state has been established or not in a state of the collective body after the move in the line direction and the column direction relating to the moving line.

8. The game machine of claim 1, further comprising a component object information storage portion which stores component object information where the kind of the component object is set for each of the plural columns in an order that the component object is displayed by the display portion,
the collective body display portion supplies and displays sequentially by following the order that the component object is displayed, the component objects to the space area where the component objects have gone by the move in the column direction, the kind of each component object being set for each of the columns of the space area.

9. The game machine of claim 8, wherein
the move execution portion deletes at least one component object which is protruded out of the predetermined shape by the move in the line direction of the moving line.

10. The game machine of claim 1, wherein
the line direction is one direction out of left and right directions, and the column direction is one direction out of up and down directions.

11. The game machine of claim 10, wherein
the game control portion further has a character display portion which displays a character corresponding to the player at one side of the collective body with respect to the line direction at the display portion, and
the character display portion displays the character at the display portion such that the moving line is moved by a motion of the character, when the moving line is moved by the move execution portion.

12. The game machine of claim 10, wherein
the game control portion further has:
an operation order determination portion which determines whether a player's operation turn has come or an other player's operation turn has come;
an operation information process portion which, when the moving line is determined by the moving line determination portion and the moving distance is determined by the moving distance determination device in the player's operation turn, makes the move execution portion, the state determination portion, the component object deletion portion, and the post-deletion move portion function based on operation information indicting the moving line and the moving distance, and evaluates a result of operation performed by the player; and
an other operation information process portion which, in the other player's operation turn, executes processes based on other operation information indicating the moving line and the moving distance determined depending on the operation by the other player, and
the other operation information process portion, when receiving the other operation information, makes the move execution portion move the moving line indicated by the other operation information depending on the moving distance indicated by the other operation information in the other direction with respect to the line direction, and
makes the state determination portion, the component object deletion portion, and the post-deletion move portion function, based on the move by the move execution portion, and evaluates the result of operation of the other player.

13. The game machine of claim 12 further comprising
a communication portion which communicates with another game machine operated by the other player, wherein
the game control portion further has:
an operation information transmission portion which transmits to the other game machine, the operation information via the communication portion in the player's operation turn; and
an operation information reception portion which receives from the other game machine, an other operation information which is made depending on the operation by the other player at the communication portion in the other player's operation turn.

14. A computer readable storage medium storing a computer game program to be executed in a game machine comprising:
an operation input portion which accepts operations by a player;
a display portion which displays a game image; and
a game control portion which controls a game where a state of a collective body constituted by plural kinds of component objects is changed in reply to the operation by the player in the display portion, wherein the computer game program is configured so as to make the game control portion function as:
a collective body display portion which makes the display portion display the collective body constituted by plural columns and plural lines where the plural kinds of component objects are arranged in a column direction or in a line direction;
a computer control portion in the game machine having the game control portion controlling a game where a state of the collective body displayed at the display portion is changed in reply to operations performed by a player;
a moving line determination portion which determines a moving line to be moved out of the plural lines of the collective body;
a moving distance determination portion which determines a moving distance for which the moving line is moved in replay to a moving distance determination operation by the player;
a move execution portion which, when the moving distance is determined by the moving distance determination portion, to the collective body displayed by the display portion, moves the component objects arranged on the moving line in the line direction depending on the moving distance;
a state determination portion which, to the collective body post-moved by the move execution portion, determines whether or not the plural kinds of component objects constituting the collective body have established a predetermined state with respect to the kinds;
a component object deletion portion which, when it is determined that the predetermined state has been established, generates a deletion portion in the collective body by deleting the plural component objects establishing the predetermined state in the collective body post-moved; and
a post-deletion move portion which moves in the column direction, the component objects arranged on the column of each deleted component object so as to fill up the deletion portion generated.

15. A game machine comprising:
an operation input portion which accepts operations performed by a player;
a game control portion which controls a game; and
a display portion which displays a game image of the game, wherein the game control portion has:
a collective body setting portion which sets as the player's collective body, any one of two collective bodies each of which is constituted by plural columns and plural lines where plural kinds of component objects are arranged in a line direction and a column direction, and sets the other one of the two collective bodies as a competitor's collective body;
a collective body display portion which displays in the game image, the player's collective body and the competitor's collective body so as to be adjacent to each other;
a move process portion which, while moving the component objects arranged in a predetermined moving line for a predetermined moving distance in a direction of the competitor's collective body in the player's collective body depending on the operation by the player, moves the component objects arranged on a competitor moving line existing in a moving direction of the moving line for the predetermined moving distance in the moving direction, so as to push out the component objects by the moving line, at the competitor's collective body; and
a move-result process portion which, after the moving line and the competitor moving line moving, while executing processes relating to a score of the player based on a state of the player's collective body, executes processes relating to a score of the competitor based on a state of the competitor's collective body including the one out of the component objects arranged on the moving line which has moved into the competitor's collective body.

16. The game machine of claim 15, wherein
the move process portion has a moving line determination portion which determines the predetermined moving line by a position determination operation by the player; and
moves the component objects arranged on the moving line determined for the predetermined moving distance.

17. The game machine of claim 16, wherein the moving line determination portion displays in the game image a position specifying symbol travelling as indicating each of the plural lines constituting the player's collective body, and determines as the moving line, a line indicated by the position specifying symbol at the moment when the position determination operation is performed by the player.

18. The game machine of claim 16, wherein the move process portion further has a moving distance determination portion which determines the predetermined moving distance with respect to the moving line determined by the moving line determination portion depending on a moving distance determination operation by the player, and moves the moving line determined for the moving distance determined.

19. The game machine of claim 18, wherein
the moving distance determination portion determines the moving distance, depending on the number of times that the moving distance determination portion has been performed within a predetermined interval.

20. The game machine of claim 18 further comprising a communication portion which communicates data with another game machine operated by the competitor, wherein
the collective body setting portion sets the player's collective body and the competitor's collective body at a moment when the game starts,
the game control portion has a move information process portion which transmits to the other game machine, move information including moving line information indicating at least one moving line determined by the moving line determination portion and moving distance information indicating the moving distance determined by the moving distance determination portion, and obtains the move information of the competitor from the other game machine, and
the move process portion, when obtaining the move information of the competitor from the other game machine, while moving for the moving distance indicated by the moving distance information in a direction of the player's collective body, the plural component objects arranged on the moving line indicated by the moving line information in the competitor's collective body, moves for the moving distance, the plural component objects arranged on a line existing in the moving direction of the moving line in the player's collective body.

21. The game machine of claim 15, wherein
the move result process portion, when the component objects establishing a predetermined specific state occur in each of the collective bodies after the moving line moving, deletes the component objects establishing the specific state, moves the component objects arranged in the column direction with respect to each of the deleted component objects so as to fill up a position where the component object is deleted, and gives points to the player or the competitor based on the specific state occurred in each collective body.

22. The game machine of claim 21 further comprising a storage portion which stores supply component object information with respect to the component objects to be supplied to the player's collective body, and supply component object information with respect to the component objects to be supplied to the competitor's collective body, wherein
in each supply component object information, the kinds of the component objects are set, for each column of the corresponding collective body, in an supplying order that the component objects are supplied,
the collective body display portion supplies the component object in the supplying order set in the supply component body information for the player to a position where a space has occurred in the player's collective body, and supplies the component object in the supplying order set in the supply component body information for the competitor to a position where a space has occurred in the competitor's collective body.

23. The game system of claim 15, wherein
the game control portion further has
an operation order specifying portion which sequentially specifies, out of plural users, a user whose operation turn has come as the player, wherein
the collective body display portion displays in the game image, the collective bodies corresponding to the plural users so as to be adjacent to each other in the column direction or the line direction;
the corrective body setting portion sets as the player's collective body, the collective body corresponding to the user whose operation turn has come out of the collective bodies corresponding to the plural users, and sets the collective body adjacent to the player's collective body as the competitor's collective body,
the move process portion, in a case that the player's collective body and the competitor's collective body are adjacent to each other in the column direction, moves the moving line and the competitor moving line, by regarding the column direction as the line direction in a process of a case that the player's collective body and the competitor's collective body are adjacent to each other in the line direction,
the move result process portion executes the process relating to the score of the player and the process relating to the score of the competitor independently, by regarding the column direction and the line direction in a process for a case that the player's collective body and the competitor's collective body are adjacent to each other in the column direction as the line direction and the column direction in a process of a case that the player's collective body and the competitor's collective body are adjacent to each other in the line direction respectively.

24. The game machine of claim 23, wherein
the move process portion has a moving line determination portion which determines the predetermined moving line by a position determination operation performed by the player, and moves for the predetermined moving distance, the plural component objects arranged on the determined moving line.

25. The game machine of claim 24, wherein
the move process portion further has a moving distance determination portion which determines the predetermined moving distance with respect to the moving line determined by the moving line determination portion by a moving distance determination operation performed by the player, and moves the determined moving line for the determined moving distance.

26. The game machine of claim 25 further comprising a communication portion which communicates data with at least one other game machine, wherein
the game control portion has a move information process portion which, when the user operating the game machine being specified as the player, transmits to the at least one other game machine, move information including moving line information indicating the moving line determined by the moving line determination portion and moving distance information indicating the moving distance determined by the moving distance determination portion, and when the user operating any one of the other game machines being specified as the player, obtains the move information of the specified user from the other game machine.

27. The game machine of claim 26, wherein
the collective body display portion displays the plural collective bodies arranged successively in a predetermined direction,
the operation order specifying portion specifies as the player, the user corresponding to each collective body in an order that the plural collective bodies are arranged, and
the collective setting portion sets as the competitor's collective body, the collective body adjacent to the player's collective body in the predetermined direction out of the plural collective bodies.

28. A computer readable storage medium storing a computer game program for a game machine comprising:
an operation input portion which accepts operations performed by a player;
a game control portion which controls a game; and
a display portion which displays a game image of the game, wherein the computer game program is configured so as to make the game control portion function as:
a collective body setting portion which sets as the player's collective body, any one of two collective bodies each of which is constituted by plural columns and plural lines where plural kinds of component objects are arranged in a line direction and the column direction, and sets another one of the two collective bodies as a competitor's collective body;
a collective body display portion which displays in the game image, the player's collective body and the competitor's collective body so as to be adjacent to each other;
a move process portion which, while moving the component objects arranged in a predetermined moving line for a predetermined moving distance in the direction of the competitor's collective body in the player's collective body depending on the operation by the player, in the competitor's collective body, moves for the predetermined moving distance in a moving direction in which the moving line moves, the component objects arranged on a competitor moving line existing in the moving direction, so as to push out the component objects by the moving line; and
a move-result process portion which, after the moving line and the competitor moving line moving, while executing processes relating to a score of the player based on a state of the player's collective body, executes processes relating to a score of the competitor based on a state of the competitor's collective body including the one out of the component objects arranged on the moving line which has moved into the competitor's collective body.
